(19) United States
(12) Patent Application Publication
(10) Pub. No.: US 2026/0359868 A1
(43) Pub. Date: Nov. 12, 2026

(54) SYSTEMS AND METHODS FOR STREAMER-GOVERNED MULTI-PLATFORM ADVERTISING USING DIGITAL OVERLAYS ON REAL-TIME VIDEO FEEDS

(71) Applicant: Halo Innovative Solutions, Stone Mountain, GA (US)

(72) Inventors: Kirk Brown, Stone Mountain, GA (US); Casey Teddell Kelly, Stone Mountain, GA (US)

(21) Appl. No.: 19/749,343

(22) Filed: Jul. 21, 2026

Related U.S. Application Data
(63) Continuation-in-part of application No. 19/072,959, filed on Mar. 6, 2025, now Pat. No. 12,687,931.
Application No. 19/072,959 is a continuation-in-part of application No. 19/021,038, filed on Jan. 14, 2025, now abandoned.
Application No. 19/021,038 is a continuation-in-part of application No. 17/978,066, filed on Oct. 31, 2022, now Pat. No. 12,200,275.
Application No. 17/978,066 is a continuation-in-part of application No. PCT/US21/30361, filed on Apr. 30, 2021.
(60) Provisional application No. 63/018,513, filed on Apr. 30, 2020.

(51) Int. Cl. G06Q 30/0251; G06Q 30/0241

(52) U.S. Cl. CPC G06Q 30/0269; G06Q 30/0277

(57) ABSTRACT

Disclosed are a system and method for streamer-governed multi-platform advertising using digital overlays on real-time video feeds. The operations performed by the system may include receiving an advertisement selection from a host streamer profile, selecting a subordinate platform from a plurality of third-party media platforms, and designating an advertisement element from a plurality of advertisement elements in response to the advertisement selection. The operations may further include initializing a real-time video feed associated with the host streamer profile, broadcasting the real-time video feed to the subordinate platform, and outputting the advertisement element as an overlay on the real-time video feed. The real-time video feed remains unchanged by the outputting of the advertisement element. The advertisement element may be translated, customized, tracked, and a compensation amount may be distributed according to a defined incentive structure.

### REFERENCE TO RELATED APPLICATIONS

The current application is a continuation-in-part (CIP) application of the U.S. non-provisional application serial number 19/072,959 filed on Mar. 6, 2025. The U.S. non-provisional application serial number 19/072,959 claims a priority to the U.S. non-provisional application serial number 19/021,038 filed on Jan.14, 2025 which is a CIP application of the U.S. non-provisional application serial number 17/978,066 filed on October 31, 2022. The U.S. non-provisional application 17/978,066 is a CIP application of the Patent Cooperation Treaty (PCT) application PCT/US2021/030361 filed on Apr.30, 2021. The PCT application PCT/US2021/030361 claims a priority to the U.S. provisional patent application serial number 63/018,513 filed on Apr. 30, 2020.

### TECHNICAL FIELD

The present disclosure relates generally to advertising software systems and, more particularly, to systems and methods for streamer-governed multi-platform advertising using digital overlays on real-time video feeds.

### BACKGROUND

Broadcasting a real-time video feed to multiple third-party media platforms simultaneously presents various challenges. A third-party media platform may operate its own media servers, application programming interfaces, encoding requirements, and presentation environments, and a video transmitted to multiple platforms are processed for each destination. When supplemental visual content that is associated with a video feed is to be presented, embedding the supplemental content directly into the video stream may require re-encoding the underlying video data for each variation of the supplemental content, which correspondingly multiplies processing overhead, introduces latency, and prevents the supplemental content from being varied across platforms. In addition, once supplemental content is embedded within an encoded video stream, the content may not be capable of being modified, replaced, translated, or customized during an ongoing broadcast. For example, per-platform or per-viewer variation of the supplemental content becomes computationally impractical as the number of destination platforms increases.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a general block diagram of the system of the present invention.

FIG. 2 is a stepwise flow diagram illustrating the general method of the present invention.

FIG. 3 is a stepwise flow diagram illustrating steps for displaying the at least one specific advertisement and further distributing the at least one compensation amount in the method of the present invention.

FIG. 4 is a stepwise flow diagram illustrating steps for displaying advertisements on the real-time video feed in the method of the present invention.

FIG. 5 is a stepwise flow diagram illustrating steps for allowing the streamer to choose an advertisement category in the method of the present invention.

FIG. 6 is a stepwise flow diagram illustrating steps for using an advertisement selection algorithm to designate the at least one specific advertisement element in the method of the present invention.

FIG. 7 is a stepwise flow diagram illustrating steps for using a viewer’s geographical location to designate the at least one specific advertisement element in the method of the present invention.

FIG. 8 is a stepwise flow diagram illustrating steps for targeting advertisements to viewers in the method of the present invention.

FIG. 9 is a stepwise flow diagram illustrating steps for using a biometric analysis algorithm to designate a new advertisement in the method of the present invention.

FIG. 10 is a stepwise flow diagram illustrating steps for displaying different advertisements on different platforms in the method of the present invention.

FIG. 11 is a stepwise flow diagram illustrating steps for an advertiser to create a new advertisement in the method of the present invention.

FIG. 12 is a stepwise flow diagram illustrating steps for displaying a web hyperlink on the real-time video feed in the method of the present invention.

FIG. 13 is a stepwise flow diagram illustrating steps for distributing the compensation amount to various parties in the method of the present invention.

FIG. 14 is a flowchart of a method 1400 of multi-platform social media advertising via digital overlays on real-time video feeds, in accordance with some embodiments.

FIG. 15 is a flowchart of a method 1500 of multi-platform social media advertising via digital overlays on real-time video feeds, in accordance with some embodiments.

FIG. 16 is a flowchart of a method 1600 of multi-platform social media advertising via digital overlays on real-time video feeds, in accordance with some embodiments.

FIG. 17 is a flowchart of a method 1700 of multi-platform social media advertising via digital overlays on real-time video feeds, in accordance with some embodiments.

FIG. 18 is a flowchart of a method 1800 of multi-platform social media advertising via digital overlays on real-time video feeds, in accordance with some embodiments.

FIG. 19 is a flowchart of a method 1900 of multi-platform social media advertising via digital overlays on real-time video feeds, in accordance with some embodiments.

FIG. 20 is a flowchart of a method 2000 of multi-platform social media advertising via digital overlays on real-time video feeds, in accordance with some embodiments.

FIG. 21 is a flowchart of a method 2100 of multi-platform social media advertising via digital overlays on real-time video feeds, in accordance with some embodiments.

FIG. 22 is a flowchart of a method 2200 of multi-platform social media advertising via digital overlays on real-time video feeds, in accordance with some embodiments.

FIG. 23 is a flowchart of a method 2300 of multi-platform social media advertising via digital overlays on real-time video feeds, in accordance with some embodiments.

FIG. 24 is a flowchart of a method 2400 of multi-platform social media advertising via digital overlays on real-time video feeds, in accordance with some embodiments.

FIG. 25 is a flowchart of a method 2500 of multi-platform social media advertising via digital overlays on real-time video feeds, in accordance with some embodiments.

FIG. 26 is a continuation flowchart of the method 2500 of multi-platform social media advertising via digital overlays on real-time video feeds, in accordance with some embodiments.

FIG. 27 is a flowchart of a method 2700 of multi-platform social media advertising via digital overlays on real-time video feeds, in accordance with some embodiments.

FIG. 28 is a continuation flowchart of the method 2700 of multi-platform social media advertising via digital overlays on real-time video feeds, in accordance with some embodiments.

FIG. 29A is a flowchart illustrating a method of streamer-governed multi-platform advertising using digital overlays on real-time videos, according to some embodiments.

FIG. 29B is a continuation flowchart of the method of FIG. 29A, according to some embodiments.

FIG. 30 is a block diagram illustrating an exemplary distribution of a compensation amount, according to some embodiments.

FIG. 31 is a block diagram illustrating exemplary factors associated with determining a compensation amount, according to some embodiments.

FIG. 32 is a flowchart illustrating a method of streamer-governed advertisement selection, according to some embodiments.

FIG. 33 is a block diagram illustrating algorithm-based designation of advertisement elements, according to some embodiments.

FIG. 34 is a flowchart illustrating a method of geographic and language-based translation and output of advertisement elements on real-time video feeds, according to some embodiments.

FIG. 35 is a flowchart illustrating a method of environmental and user-data driven customization of advertisement elements, according to some embodiments.

FIG. 36 is a block diagram illustrating blockchain and smart-contract recording of advertisement selection, presentation, interaction, and compensation distribution.

FIG. 37 is a flowchart illustrating a method of determining and applying presentation characteristics and duration to advertisement elements, according to some embodiments.

FIG. 38 is a flowchart illustrating a method of receiving, associating, and tracking interactions with advertisement elements, according to some embodiments.

FIG. 39 is a time sequence diagram illustrating the sequence of advertiser creation, publication, and host-streamer selection of advertisement elements, according to some embodiments.

FIG. 40 is a flowchart illustrating a method of receiving and designating advertisement selections and further advertisement elements, according to some embodiments.

FIG. 41 is a block diagram illustrating an exemplary operating system, according to some embodiments.

### DETAILED DESCRIPTION

The embodiments discussed herein involve or relate to real-time video streaming, digital overlay rendering, and multi-platform broadcast distribution systems. Real-time video streaming may involve capturing, encoding, transmitting, and presenting video content using computerized tools and techniques (e.g., media servers, application programming interfaces, streaming protocols). For example, streaming systems may use a combination of hardware and software as a foundation for rapidly performing complex operations to capture, encode, broadcast, and present video content across a plurality of platforms. Streaming system may use one or more media pipelines, which may have a particular configuration (e.g., encoding parameters, transmission pathways, and presentation layers, as discussed below). While a media pipeline may have an initial configuration, the configuration can change over time as conditions change (e.g., a change in an advertisement selection, a change in an environmental condition, a change in a user state, etc.), which allows the system to adapt its output without interrupting the underlying video feed. For example, a real-time video feed may be input to the system, which may produce a presentation output based on the video feed and the configuration of the overlay layer. Then, based on additional input (e.g., information related to an updated advertisement selection, viewer-profile information, geographical location information, advertisement-performance information), the system may determine and automatically electronically implement a change to the overlay configuration that will lead to an updated presentation output while the real-time video feed remains unchanged.

Powerful combinations of overlay rendering techniques and simultaneous multi-platform broadcasting, together with high-processing-capability hardware, can produce sophisticated presentation systems. These systems enable a host platform to distribute a single real-time video feed to large numbers of viewers across a plurality of third-party media platforms with differentiated, per-platform overlay content, which would otherwise be impractical or impossible to accomplish by generating and transmitting a separate re-encoded video stream for each platform and each overlay variation. The results, including the results of the embodiments discussed herein, can affect various applications. For example, the disclosed system can be configured to simultaneously broadcast a real-time video feed to multiple subordinate platforms, output differentiated advertisement elements as overlays on each subordinate platform, translate overlay content according to per-platform geographical locations and languages, and customized overlay presentation according to detected environmental conditions and user states, while the underlying real-time video feed remains unchanged.

Presenting differentiated supplemental content in association with a single real-time video feed broadcast simultaneously to a plurality of third-party media platforms, without modifying or re-encoding the underlying video feed, is a complex technical problem. Embedding supplemental content directly into a video stream may require re-encoding the underlying video data for each variation of the supplemental content, which multiplies processing overload, introduces latency, and prevents the supplemental content from being varied across platforms. The solutions described herein enable a host platform to output an advertisement element as an overlay on the real-time video feed, wherein the real-time video feed remains unchanged by the outputting. Via a streamer interface associated with a host streamer profile, and in combination with subordinate streamer profiles managed by selected subordinate platforms, the host platform may receive an advertisement selection, designate a specific advertisement element from a plurality of advertisement elements, and output the designated advertisement element as an overlay in association with presentation of the real-time video feed on each selected subordinate platform. In response, the host platform may designate differentiated advertisement elements for different subordinate platforms, translate advertisement elements according to determined geographical locations and languages, and customize presentation characteristics of advertisement elements, on behalf of the host streamer profile interacting with the streamer interface. In addition, the host platform may track interaction activity, conversion activity, and advertisement-performance information associated with the outputted advertisement element and provide a performance report through the streamer interface. Further, updates to the advertisement selection may be received and implemented during the broadcasting without interrupting, re-initializing, or re-encoding the real-time video feed. Correspondingly, the advertisement element may be changed, translated, or customized without modifying or delaying the real-time video feed, and with the subordinate platforms still presenting the same underlying video feed without requiring per-platform stream regeneration.

Broadcasting a real-time video feed to a plurality of subordinate platforms with per-platform overlay output introduces new opportunities for technical improvement, including increasing the efficiency of multi-platform video distribution, allowing a host streamer profile to govern advertisement presentation across multiple subordinate platforms using a single streamer interface, verifying interaction activity and conversion activity attributable to an advertisement element and subordinate platform, reducing processing overhead and latency resulting from per-platform stream re-encoding, and improving interoperability between the host platform and the plurality of third-party media platforms.

As an example, if a host streamer profile wishes to present an advertisement element as an overlay on a real-time video feed broadcast simultaneously to multiple subordinate platforms, the host streamer profile may follow one or more of the following steps:
(1.) Access a streamer interface associated with the host streamer profile managed by the host platform, wherein the host streamer profile is linked with corresponding subordinate streamer profiles managed by the plurality of third-party media platforms;
(2.) Provide an advertisement selection through the streamer interface, wherein the advertisement selection corresponds to at least one of an advertisement element, an advertisement category, an advertisement subject, an advertiser, a product, a service, an advertisement classification, or a presentation duration, and wherein the host platform designates a specific advertisement element from a plurality of advertisement elements based on the advertisement selection (e.g., a designated advertisement element identified by matching the advertisement category or by applying at least one algorithm);
(3.) Select, through the streamer interface, at least a first subordinate platform and a second subordinate platform from the plurality of third-party media platforms; and
(4.) Given the linked subordinate streamer profiles and an initialized real-time video feed associated with the host streamer profile, the host platform may be configured to automatically broadcast the real-time video feed simultaneously to the selected subordinate platforms and output the designated advertisement element as an overlay on the real-time video feed on each selected subordinate platform in order to fulfill the advertisement direction as indicated by the host streamer profile’s advertisement selection, wherein the real-time video feed remains unchanged by the outputting.

Disclosed systems and methods improve the technical field of multi-platform real-time video distribution by outputting supplemental content as an overlay separate from the underlying video stream and thereby eliminating per-platform stream re-encoding that may be otherwise required to differentiate supplemental content across platforms. Disclosed systems and methods further improve the technical field by incorporating per-platform overlay differentiation within the broadcast process, thereby allowing differentiated, translated, or customized advertisement elements to be presented on each subordinate platform from a single unmodified real-time video feed. Disclosed systems and methods also improve the functioning of computers by providing a broadcast system that allows for scalability, reduced processing overhead, reduced latency, and increased relevancy of presented advertisement elements (e.g., based on a geographical location, a language, or a detected user state).

In a first conventional arrangement, a graphic is permanently composited with a source presentation and the same completed presentation is transmitted to every destination platform, such that differentiating supplemental content across platforms requires generating and transmitting a separate composited presentation for each variation. In a second conventional arrangement, a source presentation is stopped, segmented, replaced, or interrupted to insert an advertisement. In a third conventional arrangement, an advertising system selects content for viewers without providing a streamer control over both an advertising direction and a selection of participating platforms. In contrast, in some disclosed embodiments, a common underlying real-time video feed continues across each selected subordinate platform; separately governed platform-corresponding overlays are output in association with the respective subordinate platforms; the host streamer profile controls both the advertisement direction and the participating subordinate platforms; the presentation of the same underlying feed continues without interruption; and attribution and compensation follow the platform-specific overlay presentations.

The present invention may be generally understood to be enabled through a self-contained system of computing devices, other hardware, software programs, and any other components required to enable the proper functionality of the present invention as disclosed herein. The present invention may be understood to be initialized on a host media platform, wherein the user interacts initially with the host platform in order to engage the functionalities of the present invention disclosed here. After the user has signed on, the user can access a plurality of digital advertising content access points; this interoperable system of multiple network access points enables the user to teleport from a host platform environment to multiple secondary environment content.

The present disclosure describes a method of multi-platform social media advertising via digital overlays on real-time video feeds.

Further, the present disclosure describes displaying advertisements on a live video feed distributed across multiple social media platforms, AR/VR environments, and physical locations without compromising performance.

Further, the present disclosure describes a system that delivers haptic feedback in real-time video feeds with digital overlays, wherein the haptic feedback is produced in reaction to user interactions with overlay components, therefore augmenting user engagement through tactile sensations that match the presented information.

Further, the present disclosure describes a method for synchronizing haptic feedback across multiple devices that exhibit digital overlays on real-time video feeds, encompassing the steps of detecting user interactions, generating corresponding haptic signals, and ensuring uniform tactile responses across devices within a shared environment.

Further, the present disclosure describes a system that manages user interactions in interest-based online environments using customizable digital overlays linked to NFTs and biometric verification to ensure privacy, personalization, and secure engagement.

Further, the present disclosure describes enhancing user interactions in mixed-reality environments by categorizing them into chatrooms, displaying digital overlays as identity shields, and offering interactive features like haptic feedback and holographic elements for immersive experiences.

Further, the present disclosure describes a system that through a device that’s able to use holographic imagery and an enhanced transducer that creates a better haptic experience, a holographic imagery comprised of dense light is produced that may interact with physical environments. Therefore, an individual may feel, taste, see, and sense through their senses this haptic holographic imagery and the holographic imagery may also interact with the individual. Further, an advertisement device of the system may cast the holographic imagery that the individual may feel. Further, the holographic imagery may be made interactive using software such that it can pick things up. Further, the holographic imagery may be made to be controlled and have it do things. The advertisement device that allows for interactive holographic imagery (interactive haptic holographic imagery) does not have to be stationary either.

Further, the present disclosure describes digital overhead holographic display devices that are used to generate one or more holographic images. For example, one or more devices located on a street display a digital holographic image of a city’s speed limit. When a person drives towards the image, they will see the hologram display of the city’s speed limit or an Advertisement of a local restaurant logo and/or commercial as digital overlay.

Further, the present disclosure describes holographic representations that may perceive and touch physical individuals using reversed haptic technology in an unlimited environment. The hologram (holographic representation) may detect and respond to a person’s presence, movement, and physiological signals using LIDAR, ultrasonic waves, and biofeedback technologies. Technology like focused sound waves, air pressure, or programmable smart materials can transfer tactile sensations onto the skin to replicate touch. This would let the hologram “reach out” and connect with reality. Robotic arms, plasma fields, or quantum sensors could supply the hologram physical feedback to “feel” a human. A holographic projection (holographic representation) might perceive textures, pressure, and temperature as a tangible entity. The hologram might learn to distinguish between mild and strong touch or react emotionally with AI and emotional feedback systems. These developments would make the hologram appear intelligent and able to interact with humans physically and sensorily. Ultra-advanced sensing, interacting physics fields, and intelligent algorithms would be needed to reverse haptic technology to let holograms touch people. Light-based projections would merge with physical entities to create a tangible, interactive holographic being.

Further, the present disclosure describes creating an advatar of a person in their image. Further, the advatar may be an advertisement of self. Further, the advertisement devices may work and all environments. People or things may create an image of self-casting it as holographic imagery with haptics and task it to do things because of the dense nature of the increase of pressure (air, sound, etc.) from the advertisement devices.

Further, the disclosed method and system include a holographic display system. Further, the holographic display system may include devices capable of projecting 3D holographic advertisements that interact with users through gestures, voice commands, and other biometric inputs. Further, the holographic display system uses ultrasonic haptics (ultrahaptics) to provide tactile feedback, creating an immersive interaction between users and holographic content. Further, the holographic advertisements may be projected in both virtual and physical environments using advanced holographic projectors. This system allows for interactive 3D advertisements that can be viewed from multiple angles and interacted with through hand gestures or speech. Further, the ultrasonic haptics technology of the holographic display system provides tactile feedback, allowing users to “feel” holographic objects as they interact with the advertisement.

Further, the disclosed method and system include biometric data integration. Further, the biometric data integration includes real-time analysis of biometric data such as facial expressions, heart rate, and voice tone to dynamically adapt the content of holographic advertisements to user emotions and preferences. Further, the biometric data integration enables biometric-triggered advertisement adjustments, such as changes in product suggestions or advertisement visuals based on detected user interest or disinterest. Further, the biometric sensors used for the biometric data integration capture user-specific data, such as facial microexpressions, heart rate, and voice pitch, to tailor advertisements dynamically. This real-time feedback loop ensures that advertisements remain relevant and engaging, increasing the likelihood of user interaction and conversion. For example: a user smiling at an advertisement for a product may trigger an instant discount offer, and a detected rise in heart rate during interaction could signal excitement, prompting further engagement opportunities, etc.

Further, the disclosed method and system include quantum computing and sensors. Further, an application of quantum computing for rapid biometric data analysis ensures real-time personalization of advertisements. Further, the quantum sensors may be used for ultra-precise environmental and biometric detection, to enable the system to adjust advertisements based on subtle user inputs or environmental conditions. Further, the quantum computing accelerates the processing of biometric and environmental data, enabling the system to deliver personalized holographic content in real-time. Further, the quantum sensors provide ultra-sensitive detection capabilities, such as identifying microexpressions or subtle voice modulations. These sensors enhance the precision of biometric data analysis, ensuring that advertisements respond accurately to user input.

Further, the disclosed method and system include device synchronization and secure data exchange. Further, the device synchronization and secure data exchange include quantum-assisted synchronization to ensure seamless interaction and display continuity across multiple devices (e.g., smartphones, AR glasses, public holographic displays, etc.). Further, the quantum encryption is for the secure exchange of biometric data and other sensitive information between devices and platforms. Further, the device synchronization and secure data exchange use quantum communication protocols through which devices participating in the system may synchronize holographic content seamlessly. Whether on AR glasses, smartphones, or public displays, all devices show identical content in real-time. Further, the quantum encryption ensures the secure transmission of biometrics and other sensitive data. For example, when a user interacts with a holographic QR code, their personal data is encrypted using quantum methods, protecting it from interception or misuse.

Further, the disclosed method and system include scanability and interactivity. Further, the scanability and interactivity may include the integration of holographic QR codes or other scannable elements within advertisements, allowing users to interact with the advertisement to retrieve more information or complete transactions. Further, the scanability and interactivity may include device-to-device data transfer, which is facilitated by secure protocols, enabling users to share advertisement content or interact with it collaboratively. Further, the scanability and interactivity allow the holographic advertisements to feature scannable elements, such as dynamic QR codes or interactive hotspots. Users can scan these elements with their devices to retrieve detailed information, complete transactions, or share content with others. Further, the system also supports device-to-device interaction, allowing multiple users to collaboratively engage with a holographic advertisement or share information between devices securely.

Further, the disclosed method and system include environmental adaptability. Further, the environmental adaptability may include using quantum sensors and AI algorithms to analyze real-time environmental data (e.g., lighting, crowd density) and adjust advertisements for maximum visibility and engagement. Further, the environmental adaptability may include context-aware holographic content delivery, and tailoring advertisements to the user’s physical surroundings. In the environmental adaptability, the system employs quantum sensors and AI algorithms to analyze the user’s environment based on real-time conditions, such as ambient light or crowd density and adjusts the brightness, size, or content of holographic ads to maximize visibility and relevance. For example: in a crowded environment, the hologram may increase its brightness or incorporate attention-grabbing animations, advertisements displayed at night may adopt softer lighting to avoid visual strain, etc.

Further, the disclosed method and system include cross-platform scalability. Further, the cross-platform scalability may include a usage of cloud-based quantum processing for efficient delivery of personalized advertisements to thousands of users simultaneously without performance degradation. Further, the cross-platform scalability may allow compatibility with existing social media platforms and emerging AR/VR ecosystems. Further, the cross-platform scalability may include using quantum-enhanced cloud computing which enables the system to process and deliver personalized advertisements to thousands of users simultaneously. In the cross-platform scalability, the system ensures real-time responsiveness and scalability by leveraging quantum parallelism. This functionality allows businesses to deploy the system across various social media platforms, AR/VR environments, and physical locations without compromising performance.

Further, the disclosed method and systems may include the following:
(1.) Augmented Reality (AR) Leyline Mapping System: Real-time visualization of Leylines using digital overlays. Interactive AR pathways guiding users to energy nodes with haptic feedback signaling proximity.
(2.) Holographic Storytelling Experiences: Use of holograms to narrate the cultural, spiritual, and historical significance of Leylines in real time or via pre-recorded videos.
(3.) Mood-Responsive Advertising: The use of biometric analysis algorithms to detect user mood via facial expressions and voice patterns to deliver tailored content.
(4.) Geo-Targeted AR/VR Advertising: Adapting advertisement to the user’s geographical location on Leylines, offering local services and promotions.
(5.) Holographic Events and Commerce: creating pop-up holographic marketplaces or events at Leyline sites, integrated with live-streaming and advertising.
(6.) Token-Based Revenue Sharing: implementing a Leyline token economy, distributing compensation based on user engagement with holographic ads or content.
(7.) Virtual Leyline Exploration: Offering immersive VR/AR Leyline tours, with integrated overlays showcasing sponsored products or historical facts.
(8.) Interactive Leyline CRM Dashboard: A Leyline-focused CRM system that tracks user interaction data, generates insights, and connects advertisers with users based on proximity and mood.
(9.) Cross-Platform Holographic Syndication: Allowing simultaneous streaming of holographic content across multiple platforms while dynamically adjusting ads per platform.
(10.) Customizable AR Advertising for Subordinate Platforms: Enabling advertisers to tailor AR holographic overlays for subordinate streaming platforms, with real-time control over content.
(11.) Dynamic Viewer-Based Content Customization: Adjusting holographic content based on viewer attributes like preferences, engagement history, and location.
12.) Multi-Layered Holographic Advertising: Displaying independent ads in distinct layers within the same holographic projection for different platforms or audiences.
(13.) Holographic Affiliate Marketing: Integrating an affiliate program into the AR/VR system, allowing businesses to advertise through holograms and split revenue based on conversions.
(14.)BEmotion-Driven Leyline Narratives: Combining mood analysis with AR storytelling, creating unique narratives tailored to user emotions.
(15.) Holographic Pinning of Web Hyperlinks: Allowing advertisers to pin interactive links to holographic objects on Leylines, driving traffic to their online platforms.
(16.) Leyline Data Analytics Platform: A backend system that collects data from AR/VR interactions, providing detailed reports to advertisers and platform owners.
(17.) Gamified Leyline Engagement: Introducing AR games where users explore Leylines, earning tokens or rewards for interacting with holographic content.
(18.) Interactive CRM Notifications: CRM integration allows sending location-based or mood-based push notifications through AR interfaces.
(19.) Holographic Cross-Promotion Partnerships: Allowing multiple advertisers to collaborate on holographic experiences, sharing ad space and revenue.
(20.) Dynamic Multilingual Content Adaptation: Using AI to translate holographic content into the user’s preferred language in real time.

Further, the integration of holographic displays, biometric data, and quantum technologies offers several key advantages:
(1.) Enhanced User Engagement: Interactive holograms and biometric responsiveness create immersive experiences that captivate users.
(2.) Improved Security: Quantum encryption ensures the protection of user data and advertisement content.
(3.) Real-Time Personalization: Refers to the process of dynamically tailoring content, recommendations, or experiences to individual users based on their preferences, behaviors, and contextual data—instantly as they interact with a platform or system. This process uses a combination of data collection, analytics, and AI-driven decision-making to adapt and optimize the user’s experience in real time.

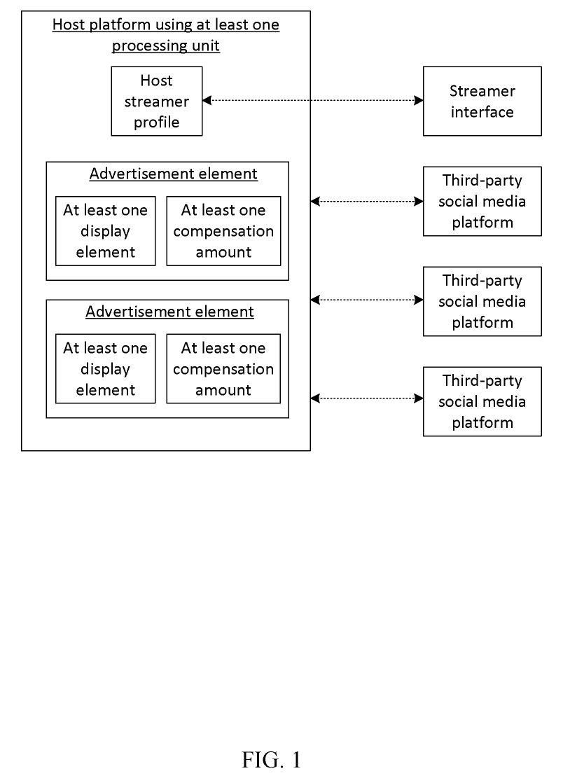

In general, referring to FIG. 1, the present invention is a new form of multimedia distribution and digital advertising content and metadata for Internet marketing, social media marketing, and Geospatial and Geo fencing marketing. In some embodiments, the present invention may be known as Focus Fast ads. The present invention is a new form of multimedia distribution of digital advertising content and metadata. This method of advertisement allows a host streamer profile to receive incentives (monetary or otherwise) with or without participating third-party media platforms by posting advertisement content to or from a participating platform or a plurality of participating platforms, enabling multi-cloud and multiplatform connectivity over any network.

This process allows sharing of advertising (ad) revenue between a host platform of the present invention, a user understood for the purposes of illustration to be engaging with the functionalities of the present invention through a host streamer profile registered with the host platform of the present invention, and a plurality of participating third-party social and live streaming platforms further registered and prepared to interact with the host platform of the present invention. This system allows each participant to receive a percentage of advertising revenue that is generated in this system. The user allows real-time advertisements to be displayed across live streams from a user’s digital identifier (host streamer profile) to be broadcast to a plurality of linked digital identifiers on participating third-party platforms. In advertising, an individual’s personal identity may be articulated and interpreted through the User handle identifier as fluid identity, relative identity, absolute identity, Identity of self-hood, Projective identity, cultural identity, gender, identity, social identity, psychological identity, economic identity, ethical identity, and temporal identity. Utilizing a digital overlay of oneself as a brand identity in advertising involves amalgamating one’s own appearance with the company’s visual components to convey a cohesive and identifiable identity. This method may successfully personalize your brand, foster deeper relationships with your audience, and establish trust by integrating your personal identity with your brand messaging.

The method may use fluid identity, relative identity, absolute identity, and identity as selfhood, for facilitating customized and dynamic brand communication.

Incentives are based on the type of advertisement being broadcast, the advertisement length, advertisement content and advertisement time and cost, but are not limited to these factors. In some embodiments, participating platforms may only receive shares of revenue when initial user selects them from a list of participating platforms.

In order to enable the method of the present invention, a host platform is provided. The host platform manages a plurality of advertisement elements, wherein each of the plurality of advertisement elements is associated with at least one display element and at least one compensation amount, and wherein the host platform uses at least one processing unit to execute computer-executable instructions stored on a non-transitory computer-readable medium. The specific nature of the plurality of advertisement elements is purposefully left generally vague herein in order to accommodate a wide variety of different attributes, elements, and other factors that may potentially be desirable for use in various embodiments of the present invention.

In an embodiment, WiFi connection or hotspots, a dialup Internet connection, cable modem, DSL, mobile Internet, broadband, cable, satellite, ISDN, T1 lines, T3 lines, optical carrier, and the like, through an Internet service provider and an Internet browser application installed on the computing device in order to access the functionality of the present invention.

Fundamentally, however, each of the plurality of advertisement elements is a digital, visual element. Examples of the type of digital visual elements that may make up an advertisement element include, but are not limited to: 2D, 3D, multidimensional images, NFT content, holograms, still or motion graphic in actual reality or augmented reality, virtual reality, mixed reality, CGI, VFX, SFX or after effect overlays. Advertisement overlays may be transparent or have a certain opacity to the overlays. Some advertisements may include text, image, or video with audio. The system employs quantum sensors and AI algorithms to analyze the user’s environment. Based on real-time conditions, such as ambient light or crowd density, the system adjusts the brightness, size, or content of holographic advertisements to maximize visibility and relevance. The advertisement overlays may be accompanied with different types of streamers’ overlays such as, but not limited to, webcam overlays, informational overlays, augmented reality overlays, sponsor overlays, stream label overlays, game overlays, and talking screen overlays.

The present invention may further include recognition of advertising information. Advertising information may be in the form of audio, visual, audiovisual, textual, and haptic content, among others. The audio element may be musical, spoken, or other audio. Visual content may include visually consumable content which may contain multidimensional imaging. Said multidimensional imaging may include two or more spatial dimensions and may also include a time dimension. Superimposed animated multidimensional images may be used as source user identification. Fluid identity, relative identity, absolute identity, and self-hood are detectable digital representations under the present invention.

All parties to the present invention such as users, advertisers, and third parties may utilize advertising material and secret data with a unique identifier to share immersive and interactive physical reality or extended reality in real and/or virtual worlds. Audio visualization, data visualization, and virtualization as used in the present invention may make use of device cameras and motion sensors to project virtual and physical content into a user’s view. Sensors may also be installed on devices related to the present application such as wearable devices. These sensors may measure energy generation, temperature, weather, and other measurements as needed to improve operation and visualization. Virtual models can be used to run simulations, evaluate performance difficulties, and suggest improvements to real physical objects and spaces. Digital copies of objects such as autos, real estate, art, apparel, and others may be used as advertising content in the current invention’s system and method. Digital copies can be created using image manipulation and modification techniques.

Each of the plurality of advertisement elements is further associated with one or more compensation amounts or means, wherein said compensation amounts or means are initialized in the system of the present invention as a reward for displaying its corresponding advertisement element on a live video stream. Further, after an advertisement element is displayed on a live stream, the at least one compensation amount is distributed to both the live streamer and any third-party platforms they may be further streaming to. The compensation amount may vary according to various attributes as desired in various embodiments, and/or designated in accordance with each individual advertisement element. The compensation amount, or incentive(s), may be based on factors such as, but not limited to, the type of advertisement being broadcast, the advertisement length, advertisement content and advertisement time and cost, or other relevant factors.

Further, a plurality of third-party media platforms is provided. Further, a host streamer profile is provided, wherein the host streamer profile is managed by the host platform, wherein the host streamer profile is associated with a streamer interface. Finally, before the general method of the present invention can begin, the user to interact with the present invention must access the Internet via a digital device, such as, but not limited to, a personal computing device, a smartphone, tablet, wearable devices, smart glasses, public holographic displays or any other suitable computing device. The computing device of the user may access the Internet or spatial web through any applicable means, such as, but not limited to, a WiFi connection or hotspot, a dialup Internet connection, cable modem, DSL, mobile Internet, broadband, cable, satellite, ISDN, T1 lines, T3 lines, optical carrier, and the like, through an Internet service provider and an Internet browser application installed on the computing device in order to access the functionality of the present invention. Further, alternative means through which the user may directly connect to elements of the present invention may include, but are not limited to, cloud computing with a virtual private network to access the server(s) of the present invention through an encrypted connection, a remote desktop server, a virtual desktop infrastructure, or other applicable means.

In general, one or more computing devices may be used to carry out the method described herein. This may be a server computer connected to client devices over a network such as the Internet. Specific computing setups using devices such as desktop computer, laptop, tablet, personal digital assistant, portable electronic device, wearable computer, smart phone, Internet of Things (IoT) device, smart electrical appliance, game console, rack server, super-computer, quantum server, mainframe computer, mini-computer, micro-computer, blockchain server, IPFS server, and storage may act as the one or more client devices and/or the server computer in the above-outlined setup. These devices may be set up to run software, including, but not limited to, an operating system (e.g., Windows, Mac OS, Unix, Linux, Android, etc.), to provide a user interface (e.g., GUI, touch-screen based interface, voice based interface, gesture based interface, etc.) for use by the one or more users and/or a network interface for interacting with other devices over the network. In light of this, the server computer may include a processing device for processing data, such as, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. The server computer may also come equipped with a communication tool for connecting to one or more external devices. The one or more external devices could be anything from a client device to a third-party database to a public database to a private database, among other things. The communication device may also be set up to communicate with one or more external devices through a variety of routes. A wireless communication channel and/or a wired communication channel may also be included in the one or more communication channels. As a result, the communication device may be set up to carry out one or more electronic information transmissions and receptions. A storage device set up to carry out data storage and/or retrieval operations may also be present on the server computer. In general, the storage device may be set up to offer dependable digital information storage. As a result, the storage device may, in certain implementations, be built using technologies like data compression, data backup, data redundancy, data deduplication, error correction, data fingerprinting, role-based access control, and so on. The storage device may also be configured as volatile or non-volatile storage for secret data encrypted keys as a form of security for connection authorization and transaction validation. The storage device may operate through centralized cloud storage, interplanetary file system storage, digital wallet storage, stored value card, or decentralized blockchain storage, according to some embodiments.

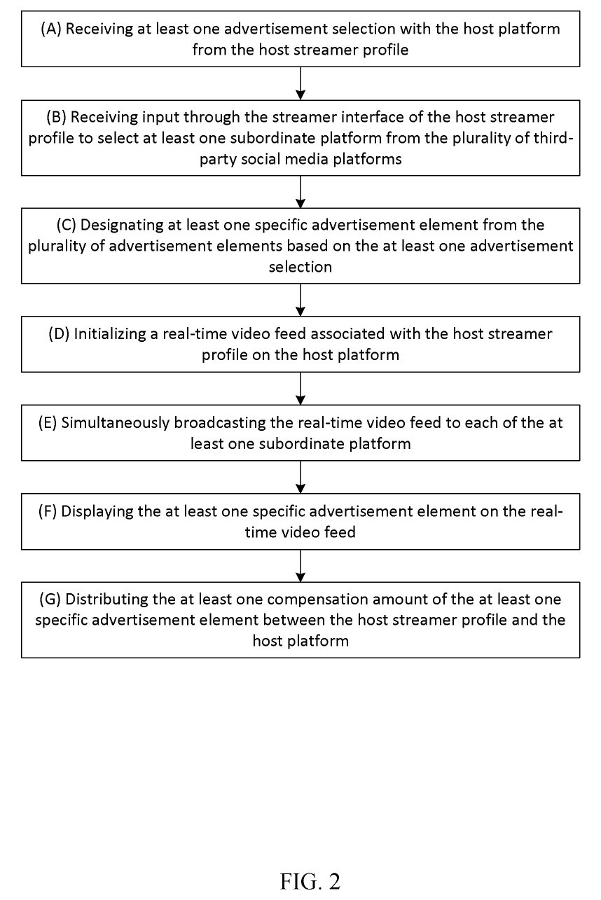

In the general method of the present invention as illustrated in FIG. 2, at least one advertisement selection is received with the host platform from the host streamer profile (step A). Input is then received through the streamer interface of the host streamer profile to select at least one subordinate platform from the at least one media platform (step B). Further, the at least one media platform may include a plurality of third-party social media platforms. Wherein the host streamer profile initiates a real-time video feed on the host platform, each subordinate platform essentially plays the role of repeating or copying the real-time video feed from the host platform, with some potential exceptions in different embodiments, as will be discussed hereinafter. At least one specific advertisement element is designated from the plurality of advertisement elements based on the at least one advertisement selection (step C). The at least one specific advertisement element corresponds to one or more (hence “at least one”) advertisement elements to be displayed on the real-time video feed. The determining, or selection process, of the at least one specific advertisement element may vary in different circumstances and/or in different embodiments, as will be discussed hereinafter.

Subsequently, a real-time video feed associated with the host streamer profile is initialized on the host platform (step D), the real-time video feed is simultaneously broadcast to each of the at least one subordinate platform (step E), and the at least one specific advertisement element is displayed on the real-time video feed (step F) as the real-time video feed is simultaneously broadcast to each of the at least one subordinate platform.

The multifarious superimposed digital content advertisement displayed on-screen within a social media network/platform and/or to a plurality of social networking platforms is broadcast with various types of superimposed digital content advertisement that is integrated into the video content as overlay advertising which may appear at any desired location, such as, but not limited to, the bottom, top, left, right or center of the user device screen during a live stream or recorded broadcast of user content.

Finally, the at least one compensation amount of the at least one specific advertisement element is distributed between at least the host streamer profile and the host platform (step G). More specifically, in some embodiments and/or circumstances, the at least one compensation amount of the at least one specific advertisement element is distributed among the host streamer profile, the host platform, and each of the at least one social media platform.

In various embodiments, the specific nature of the real-time video feed may vary. In some embodiments, the real-time video feed is a live-stream video feed, wherein the live-stream video feed continually receives video input from the host streamer profile. The continually received video input may be received through a digital image capture device, such as, but not limited to, a digital camera or webcam attached to a computing device used to interact with the host platform of the present invention through the host streamer profile. Alternatively, in some embodiments, the real-time video feed may be a real-time broadcast of a prerecorded or pre-edited video file. In various embodiments, the real-time video feed may stream any type of video with the present invention.

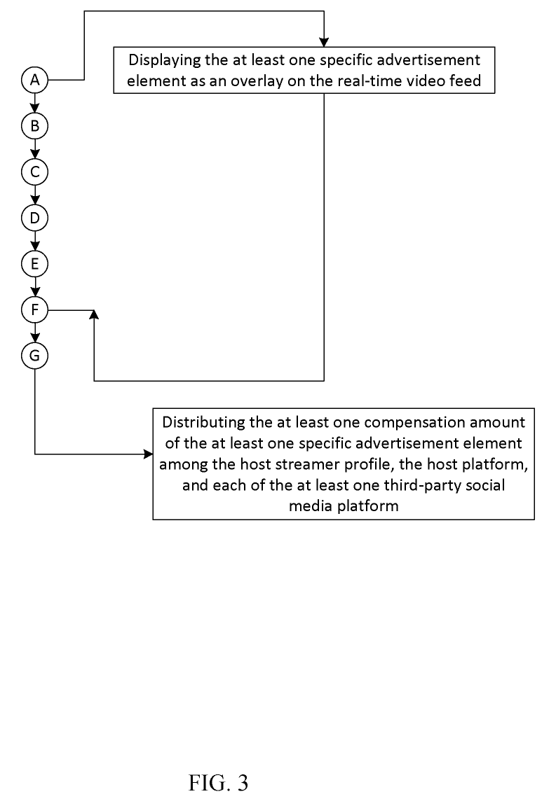

In the preferred embodiment of the present invention, the at least one specific advertisement element may be displayed in any suitable manner and/or form on the real-time video feed. In the preferred embodiment, the at least one specific advertisement element is displayed as an overlay on the real-time video feed, as shown in FIG. 3. The real-time video feed may remain unchanged by the displaying of the at least one advertisement element, or in some embodiments, an advertisement element may include one or more functionalities of modifying the real-time video feed itself, through means such as, but not limited to, stretching, shrinking, color shifting, warping, or any other relevant visual video effects.

Further, in the preferred embodiment, a color shifting in pixel-based display systems may be managed and corrected. In pixel-based display systems. Color shifting occurs when the perceived color of a pixel changes due to factors such as viewing angle, lighting conditions, or subpixel misalignment. The described system employs real-time monitoring and adaptive algorithms to analyze and adjust pixel color values dynamically. By integrating machine learning models, the system can detect and correct color inconsistencies, ensuring accurate and consistent color representation across various display environments. This method improves image fidelity, reduces perceptual artifacts, and enhances the overall viewing experience, especially in high-resolution displays like LED, LCD, QNED, QLED, and OLED screens. Holographic technologies, especially digital and computational holography, often rely on voxel or pixel liked elements to store, manipulate, and display the holographic data.

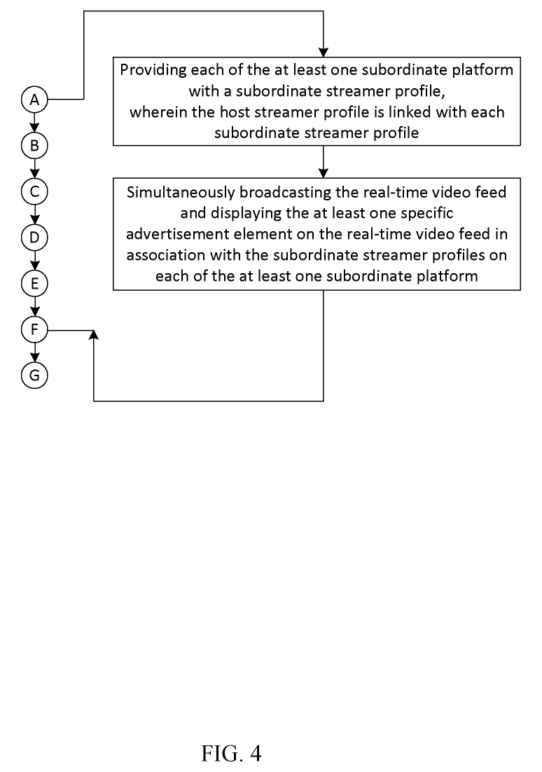

Further, in the preferred embodiment, each of the at least one subordinate platform is provided with a subordinate streamer profile, wherein the host streamer profile is linked with each subordinate streamer profile. This may be accomplished through any suitable means, such as, but not limited to, an application programming interface (API) and Real-Time Messaging Protocol (RMTP), or any other suitable and relevant means for enabling suitable communication between the host platform and each of the at least one subordinate platform. Further, as shown in FIG. 4, the real-time video feed is simultaneously broadcast and the at least one specific advertisement element is displayed on the real-time video feed in association with each of the subordinate streamer profiles on each of the at least one subordinate platform.

In some embodiments and/or circumstances, in order to determine the at least one advertisement selection, a category selection may be received as one of the at least one advertisement selection. A list of matching advertisement elements from the plurality of advertisement elements to may then be displayed the host streamer profile, wherein each of the list of matching advertisement elements corresponds to the category selection. In various embodiments, the category selection may correspond to any suitable and relevant category. For example, the category selection may correspond to the streamer’s mood. If the streamer’s mood is happy, they may click a “happy” option from a list of categories, or they may type the word “happy” into a search field, as desired in different embodiments. Thus, advertisements from the mood query and a list of advertisers with cheerful products or service will formulate. Further, the category selection may correspond to a specific field, or hobby; for example, American football. Thus, upon receiving a category selection corresponding to American football, advertisements may populate a list displayed to the streamer profile related to the subject of American football.

In the preferred embodiment, the user associated with the host streamer profile can choose advertisements to run which have the best incentives. This process helps the user select advertisements that align with the mood of their live stream presentation or incentive level.

These advertisements can differ in visual presentation and time length. The advertisement may be strategically placed over the user’s live stream in time intervals during a live broadcast or prerecorded video that is multicast, simulcast, geo-cast, or recast to a plurality participating platform. A Focus Fast geographic information system of the present invention may give advertisers the most accurate insight to plan direct advertising campaigns by customer purchasing patterns for customer targeting by demographic or geographic locations. Artificial intelligence, machine learning, and advanced analytics will help direct advertisements based on the geographical location of viewers. For example, if a user is watching from a non-English speaking country, the advertisement will be broadcast to them in a native language such as Hindi, Spanish, Cantonese, etc. Focus Fast advertisement does not stop, pause, or break up the user’s live stream feed.

These advertisements can differ in visual presentation and time length, such as but not limited to advertisements placed on moveable or non-movable object surfaces for brand placement like virtual clothing, autos, or objects displaying brand identifiers. The advertisement may be identifiable at continuous verifiable points or strategically placed over the user’s live stream in time intervals during a live broadcast or prerecorded video that is multicast, simulcast, geo-cast, or recast to a plurality participating platform. Advertisement visualization may be in the form of data visualization, audio visualization, virtual machines, digital twins, hypervisors, and others. The source user may receive digital assets, currency, or other transferred earned benefits for the digital advertising content. A geographic information system of the present invention may also give advertisers the most accurate insight to plan direct advertising campaigns by customer purchasing patterns for customer targeting by demographic or geographic locations. Artificial intelligence, machine learning, and advanced analytics will help directing advertisements based on the geographical location of viewers. The Focus Fast Ad overlay system is designed to enhance user immersive experience within actual reality, virtual reality, or augmented reality by displaying advertisement elements such as but not limited to independent and dependent brand identifiers for a service or product.

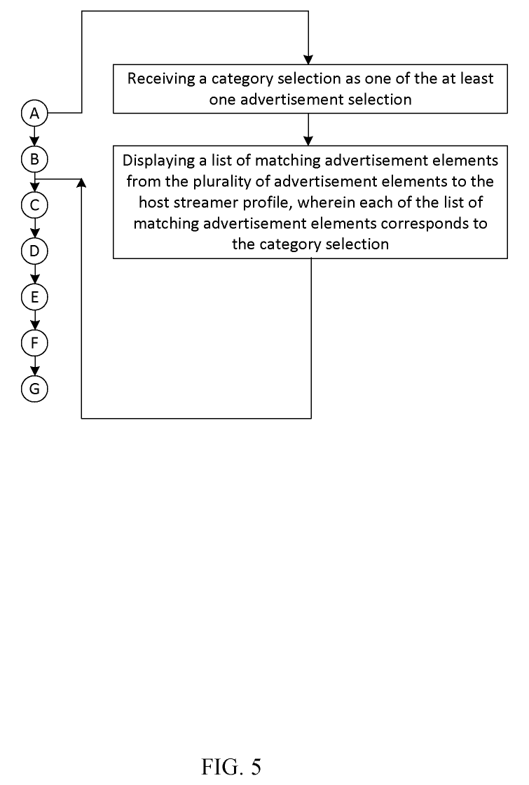

In some embodiments, the category selection may be all that is needed to designate the at least one specific advertisement element to be displayed on the real-time video feed. In some other embodiments, after making the initial category selection, the streamer may further narrow which advertisement or advertisement type to display on their live stream by choosing from a list of categorized advertisement elements populated due to the category selection. Thus, an advertisement selection may be received with the host platform from the host streamer profile, wherein the advertisement selection corresponds to a specific advertisement element from the list of matching advertisement elements, as shown in FIG. 5. The specific advertisement element may then be designated as the at least one specific advertisement element with the host platform. An advertising element, event or notification can trigger digital overlays on movable or non-moveable surfaces through interactive continually verifiable points during real-time video feeds in reality, augmented reality, virtual reality, mixed reality, reality AI, and/or holographic reality.

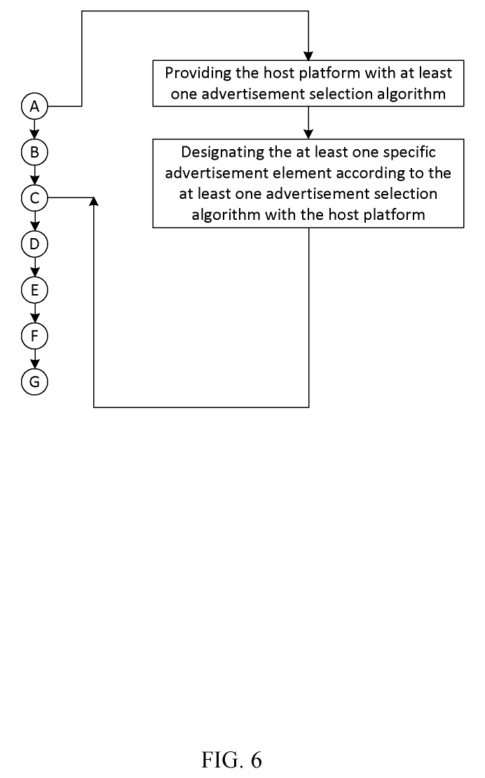

In some embodiments, the host platform may be provided with at least one advertisement selection algorithm, as shown in FIG. 6. The at least one specific advertisement element is thus designated according to the at least one advertisement selection algorithm with the host platform. The at least one advertisement selection algorithm may vary as desired in different embodiments. In some embodiments, the at least one advertisement selection algorithm may comprise at least one artificial intelligence (AI) algorithm, which may take any suitable form of artificial intelligence algorithm. The at least one artificial intelligence algorithm may comprise one or more algorithms that may work in conjunction with each other in order to designate the at least one specific advertisement element based on any number of factors, which may be designated by the host platform and unchangeable, or the at least one artificial intelligence algorithm may take input from the host streamer profile, from the real-time video feed of the host streamer profile, from one of the at least one media platforms, or from another source. Further, the at least one media platform may include the plurality of third-party social media platforms.

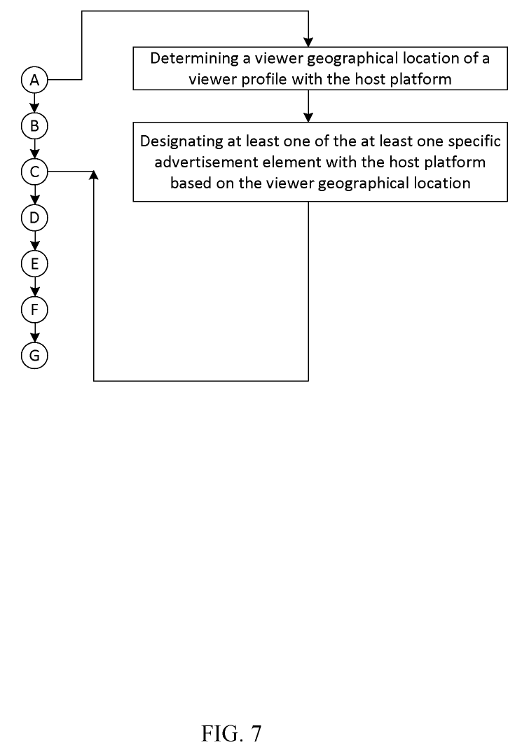

In some embodiments, a viewer geographical location of a viewer profile may be determined with the host platform, as shown in FIG. 7. The determining of the viewer geographical location may be facilitated through any known and relevant means, such as, but not limited to, ordinary geofencing practices and processes known in the art, or new practices and processes. At least one of the at least one specific advertisement element may then be designated with the host platform based on the viewer geographical location.

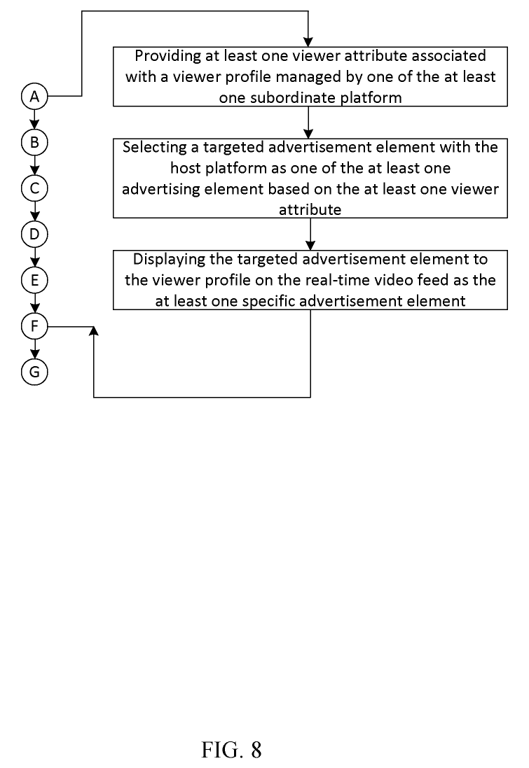

Further, in some embodiments, at least one viewer attribute is provided, wherein the at least one viewer attribute is associated with a viewer profile managed by one of the at least one subordinate platform. As shown in FIG. 8, a targeted advertisement element may then be selected with the host platform as one of the at least one advertising element based on the at least one viewer attribute, and the targeted advertisement element is then displayed to the viewer profile on the real-time video feed as the at least one specific advertisement element.

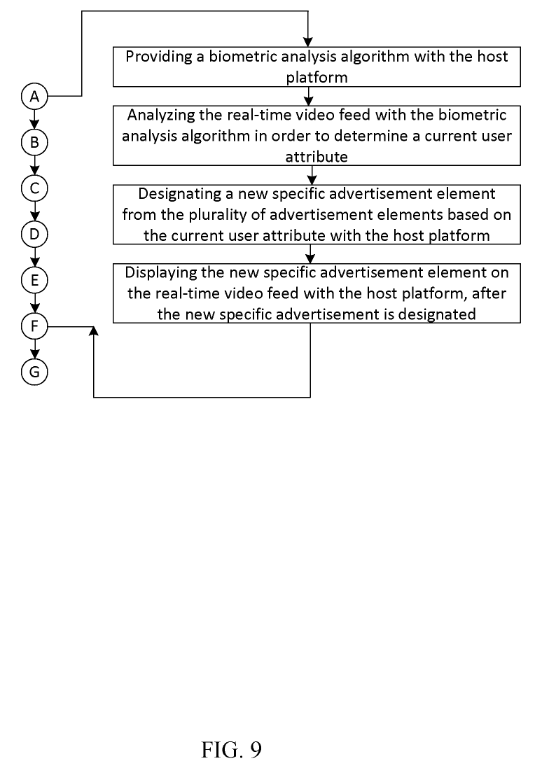

Further, in some embodiments, as shown in FIG. 9, a biometric analysis algorithm may be provided with the host platform. Further, the biometric analysis algorithm may include a biometric video analysis algorithm. In some embodiments, the biometric analysis algorithm may be provided as the at least one artificial intelligence algorithm, or the biometric analysis algorithm may be provided to supplement or operate separately from the at least one artificial intelligence algorithm. Biometric data may be collected using AI, machine learning, and/or deep learning to categorize personal advertisement placement or recommendations for the user. This process uses a combination of data collection, analytics, and AI-driven decision-making to adapt and optimize the user’s experience in real time. The real-time video feed may thus be analyzed with the biometric analysis algorithm in order to determine a current user attribute. The current user attribute may correspond to, for example, the user’s current mood, wherein the biometric analysis algorithm may be configured to analyze human facial expressions with biometric video analysis and/or human speech patterns with biometric audio analysis and thereby determine a current mood of the live streamer. Other biometric aspects may further or alternatively be determined by the biometric analysis algorithm, such as, but not limited to, measurements of the streamer’s body, in order to estimate a specific size of clothing to advertise to them, for example, or any other relevant biometric attributes. To customize ads, biometric sensors collect user data including heart rate, voice tone, and facial expressions. This real-time feedback loop keeps advertisements relevant and engaging, enhancing user engagement and conversion. For example, a user smiling at a product advertisement may trigger an instant discount offer, while a detected surge in pulse rate during contact may signify enthusiasm, promoting continued engagement.

Real-time analysis of biometric data such as facial expressions, heart rate, and voice tone to dynamically adapt the content of holographic advertisements to user emotions and preferences. Furthermore, in some embodiments, quantum computing for rapid biometric data analysis, ensuring real-time personalization of advertisements. Quantum sensors for ultra-precise environmental and biometric detection enable the system to adjust advertisements based on subtle user inputs or environmental conditions.

Biometric-triggered advertisement adjustments, such as changes in product suggestions or advertisement visuals based on detected user interest or disinterest. Extending biometric identification to incorporate physiological or emotional reactions to material for more customized experiences is the goal of advanced biometric feedback.

Interactive AR/VR Integration: Bringing AR and VR technology to the table to further immerse consumers, letting them go on completely virtual dates or attend virtual events.

The ability for NFTs to dynamically change over time in response to user activity, granting access to additional features, prizes, or capabilities

Haptic feedback may be further used in conjunction with a holographic broadcast display of live or recorded content and advertisement. A Holographic Display System for devices capable of projecting 3D holographic advertisements that interact with users through gestures, voice commands, and other biometric inputs. Use of ultrasonic haptics (ultrahaptics) to provide tactile feedback, creating an immersive interaction between users and holographic content. Holographic advertisements can be projected in both virtual and physical environments using advanced holographic projectors. These systems allow for interactive 3D advertisements (advertisement element) that can be viewed from multiple angles and interacted with through hand gestures or speech.

The use of haptic feedback in the digital overlay system on real-time video feeds improves the user experience by adding another sensory dimension. When users engage with overlay components, such as adverts or scannable features, the system creates tactile sensations, such as vibrations, pulses, or ultrasonic textures. These haptic reactions align with the presented material, offering consumers prompt and instinctive feedback that enhances engagement and interaction. For example, when a user picks an item in an advertisement, a subtle vibration can validate the interaction, enhancing the immersive and responsive experience.

Ultrasonic haptics technology integrates the synchronization of haptic responses across various devices to provide a uniform and cooperative experience across platforms. In a shared environment where numerous users interact with the same digital overlay—such as observing a holographic advertisement on a public screen—each user’s device produces identical haptic feedback in response to the interaction. This synchronization is accomplished using exact timing standards and flexible feedback methods, guaranteeing that all users receive uniform tactile sensations irrespective of device kind or location. By facilitating further iterations.

Further, in some embodiments, a new specific advertisement element from the plurality of advertisement elements may be designated based on the current user attribute with the host platform, and the new specific advertisement element is subsequently displayed on the real-time video feed with the host platform, after the new specific advertisement is designated. Alternatively stated, in some embodiments the biometric analysis algorithm may detect changes in the user’s mood or other attributes and correspondingly change what advertisement element is currently displayed on the real-time video feed as a result. Implementations may consist of biometrically recommended advertisements based on the streamer’s emotion expressed during the live stream or recorded video such as, but not limited to, facial expressions, vocal level pattern or cadence, or other factors. Further, in some embodiments, the digital overlays and user involvement may be enhanced using biometric verification, NFT-based identities, haptic feedback, and holographic aspects to improve user interaction. Biometric authentication secures interest-based chatroom access. After verification, users are represented by dynamic NFT-based digital overlays that act as anonymous avatars, preserving privacy and customization.

These NFTs may be adjusted based on user choices, hobbies, or platform involvement to visually reflect and protect user privacy. By using NFTs to represent user identities, interactions remain anonymous while allowing for customization and social expression on the platform. The operational procedure starts with biometric verification, employing face recognition, fingerprint scanning, or alternative biometric methods to verify the user. This measure bolsters security by removing the necessity for conventional login credentials and guaranteeing that the user is distinctly authenticated for platform access.

Upon authentication, individuals are classified into interest-based chatrooms according to their stated preferences or interests. In these chatrooms, participants’ identities are represented via NFTs that serve as dynamic digital overlays. These NFTs function as customized avatars, enabling users to preserve anonymity while conveying their identification through their digital assets.

Additionally, the system offers interactive functionalities like haptic feedback and holographic components. Users can perceive tactile sensations via haptic feedback when engaging with NFTs or digital overlays in their surroundings. For instance, interacting with a virtual item or digital advertisement may elicit a vibration or other physical feedback, enhancing immersion.

Furthermore, holographic components are included in the system, allowing the projection of digital overlays in three-dimensional space, hence enhancing immersive and engaging user experiences. This may encompass, for instance, the utilization of holograms for interactive virtual avatars or advertisements that users may engage with in real-time, hence augmenting engagement and immersion.

Improvements in Privacy, Security, and Engagement: The incorporation of biometric authentication guarantees secure verification of the user’s identification, while the utilization of NFTs as digital overlays safeguards and personalizes user identities. The integration of these technologies cultivates a safe, anonymous environment for users, facilitating engaging and dynamic interactions.

The integration of haptic feedback and holographic components enhances the user experience by offering multimodal engagement, hence augmenting interaction with both the platform and the presented adverts. These innovative features augment the current framework while maintaining the original objective of improving user engagement in real-time video and interactive content environments.

Further, the devices used in the present invention may be configured for receiving and transmitting brainwave data and neural data. In embodiments involving these devices, digital content such as advertising content, surrounding content, and user feedback may be in the form of brainwave data or neural data. The present invention also allows for a learned AI system to download brainwave data, receive and record data for exchangeable consumption of memory, senses, reasoning, and other neural processes. Such embodiments may further comprise the release of substances into a duct or opening to a user’s body.

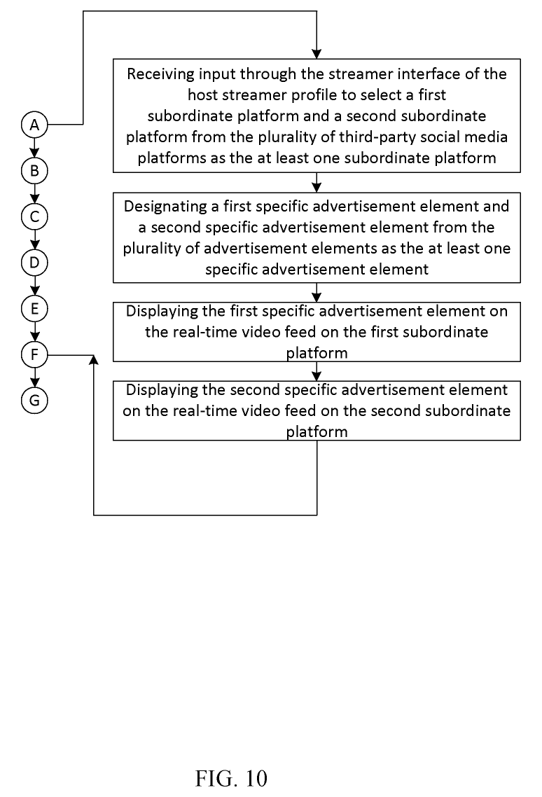

Further, in some embodiments, the present invention may display different advertisement elements on different platforms. To this end, as shown in FIG. 10, input may be received through the streamer interface of the host streamer profile to select a first subordinate platform and a second subordinate platform from the at least one media platform as the at least one subordinate platform. Further, the at least one media platform may include the plurality of third-party social media platforms. A first specific advertisement element and a second specific advertisement element are then designated from the plurality of advertisement elements as the at least one specific advertisement element. The first specific advertisement element is then displayed on the real-time video feed on the first subordinate platform, while the second specific advertisement element is simultaneously displayed on the real-time video feed on the second subordinate platform, wherein the underlying real-time video feed remains unchanged between the first subordinate platform and the second subordinate platform, but different advertisement elements are displayed on each subordinate platform. This may, for example, correspond to the aforementioned geofencing feature, such as a viewer or platform located in Italy may be shown an Italian-language advertisement element, while a viewer or platform located in Washington, D.C. may receive an English-language advertisement element.

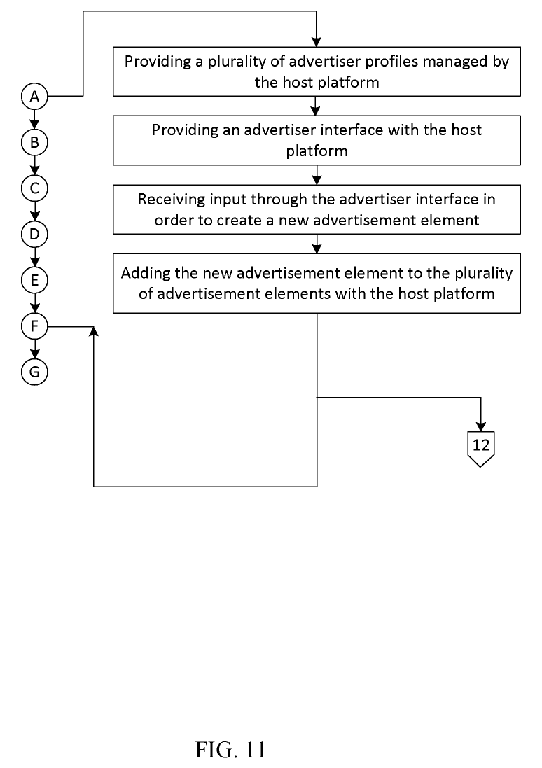

Further, in the preferred embodiment, entities who wish to have their advertisements displayed on video feeds through the present invention may interact with the host platform and general system of the present invention in order to initialize and customize their advertisements. To this end, a plurality of advertiser profiles is provided, wherein the plurality of advertiser profiles is managed by the host platform. Further, as shown in FIG. 11, an advertiser interface is provided with the host platform through which each of the plurality of advertiser profiles may interact with the host platform in order to set up and customize their desired advertisements. Thus, input may be received through the advertiser interface in order to create a new advertisement element, and the new advertisement element is subsequently added to the plurality of advertisement elements with the host platform, and the operation of the present invention may proceed as previously described.

Advertisers may have varying degrees of control and customization over their advertisements to be utilized with the present invention, as desired in various embodiments of the present invention.

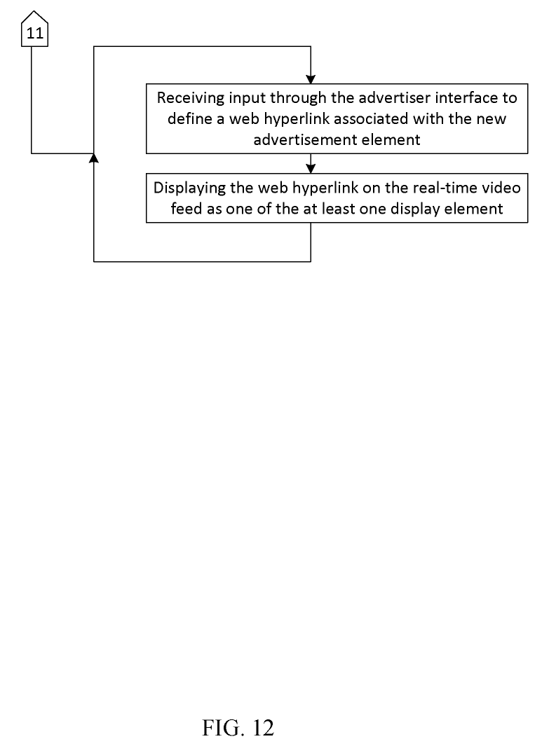

In some embodiments, as shown in FIG. 12, input may be received through the advertiser interface to define a web hyperlink associated with the new advertisement element. The web hyperlink may be displayed on the real-time video feed as one of the at least one display element. A viewer may click on the web hyperlink in order to be taken directly to a product webpage, company webpage, subordinate platform, or other webpage through the web hyperlink, as designated by the associated advertiser profile. The present invention may further track the viewer’s activity after engaging with the web hyperlink and may collect information about whether the user buys a product or not after viewing the advertisement and clicking the web hyperlink. This may be referred to as a sale conversion.

Finally, after the at least one specific advertisement element is designated and displayed on the real-time video feed in accordance with the foregoing disclosure, the at least one compensation amount may be distributed. The specific distribution scheme for the at least one compensation amount may vary as desired in different embodiments. For example, an advertiser may designate a three-way split for the compensation amount between the host platform, the streamer profile, and the at least one subordinate platform. Thus, the host platform, the streamer profile, and the at least one subordinate platform each has an incentive to participate in the operation of the present invention.

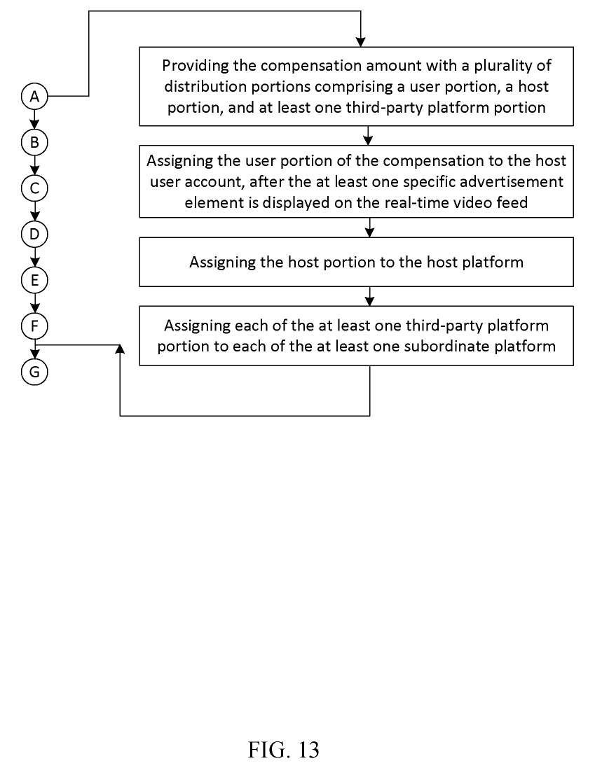

To this end, in some embodiments, the compensation amount may be provided with a plurality of distribution portions comprising a user portion, a host portion, and at least one third-party platform portion. As may be expected, as shown in FIG. 13, after the at least one specific advertisement element is displayed on the real-time video feed, the user portion of the compensation amount is assigned to the host streamer account, the host portion is assigned to the host platform, and each of the at least one third-party platform portion is assigned to each of the at least one subordinate platform. Further, the host streamer account may include a user account.

Further, in some embodiments, the at least one compensation amount may be in the form of transferrable tokens and keys associated with the transfer, sale, investment, or other transaction related to non-fungible tokens. In such embodiments, the step of distributing the at least one compensation amount further comprises the compensation amount being associated with a transferrable digital token and related data. The use of transferrable digital tokens with the present invention is not limited to the at least one compensation amount.

Furthermore, in the preferred embodiment of the present invention, the results of the various steps in the process of the present invention are recorded and stored in a blockchain as a smart contract. The blockchain may be any suitable blockchain, existing, new, or proprietary to the present invention. At each stage of the process of the present invention, various elements of the process, including, but not limited to, the selection of ads, the selection of a third-party platform, the distributed incentive, total number of impressions, and total number of actual sale conversion are recorded and stored in the blockchain as a smart contract.

In the preferred embodiment, advertisers can add their Focus Fast ads to a partnership program query list allowing users to earn incentives for picking advertisers and retailers products or services to be run during the user’s live feed. After advertisers create an advertisement campaign, they can publish it to a social network for viewing and/or choose to add it to advertisement to Focus Fast partnership query list by categories pertaining to users’ interests, mood, location, popularity, incentive opportunities, temperament, personality, disposition, creativity, and motivation but not limited to this. The Focus Fast system of the present invention allows better advertisement targeting that will separate advertisers, retailers, and media companies from their competition. It also creates a connection with customers and builds brand loyalty. Personalization marketing gives users control of who, what, when, and how advertisements are displayed in their live stream. This gives the viewers of the advertisements a visual presentation and an access link to the product and service. Further, the access link may include a product link.

The product link may be accessible to viewers who may have an interest in purchasing or learning more about the product or service. Integration of holographic QR codes or other scannable elements within advertisements, allowing users to interact with the advertisement to retrieve more information or complete transactions. Context-aware holographic content delivery, tailoring advertisements to the user’s physical surroundings and AI algorithms to analyze real-time environmental data (e.g., lighting, crowd density) and adjust advertisements for maximum visibility and engagement.

Creators: Depending on the kind of material they’re producing (serious vs. informal), creators might switch between identities using the fluid identity feature. While relative identity analytics would provide information on the kinds of material that are most popular, the self-hood notion would enable them to establish a closer connection with their followers. Further, the creators may include hosts, users, etc.

Users: Depending on the identity they are presently using, users might receive tailored content recommendations thanks to the fluid identity system. A personal identity would result in more social or entertainment-oriented recommendations, whereas a professional persona might draw recommendations based on career. Further, the users may include viewers.

Brands: Using both relative and absolute identification models to target people might be advantageous for brands. Using data from social clustering, they might target areas where their goods are more likely to be popular or verified consumers with targeted adverts or content.

Incentive (compensation amount) is given to the host streamer profile if they run ads, if their total viewers’ market reach is exceeding, or if a sale conversion is initiated through the host user profile’s real-time video feed. Each stage of the process from the selection of ads, the selection of a third-party platform, the distributed incentive, total number of impressions, and the total number of actual sale conversions is recorded and stored in a blockchain as a smart contract. In some embodiments, blockchain may be encrypted using Symmetric Encryption, Asymmetric Encryption, Hashing, and Quantum encryption for secure exchange of biometric data and other sensitive information between devices and platforms. Users can give Focus Fast Ads access to their live stream in order to allow automated advertisements, or the user of the host streamer profile can block advertisements by activating relevant user control functions. Cross social network marketing allows users to run advertisements on different social platforms. Before a live stream a user can select an advertisement, or an advertisement is selected for them and placed based on collected user data.

The user can add participating social networks to their live broadcast to allow cross social platform advertising. Higher advertisement impressions and conversions are achieved when the advertisement is spread to multiple platforms. Focus Fast cross platform marketing extends advertisers’ reach to customers with relevant and useful advertisements more than traditional in-house platforms. This system helps give advertiser insights into how effective their advertisement campaign is for their product or service. Focus Fast ad artificial intelligence, machine learning algorithms, data science, and deep learning create performance analytic reports that track, measure, and forecast ads’ performance, giving easy access to key metrics of marketing data such as total clicks, conversion rate, cost per conversion, impressions, cost per impression, but not limited to this. Live streamers also have access to their advertisement placement performance such click through rate (CTR), and revenue earn per mile (RPM), helping users optimize the advertising they place on their live stream. The user can see which advertisements are earning them the most money and which are not.

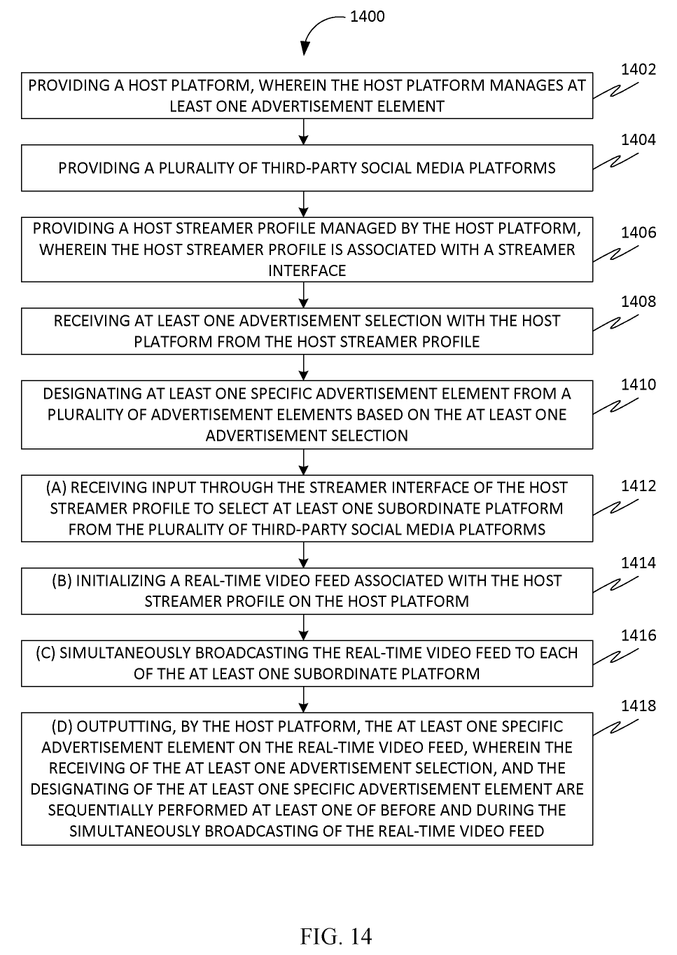

FIG. 14 is a flowchart of a method 1400 of multi-platform social media advertising via digital overlays on real-time video feeds, in accordance with some embodiments. Accordingly, the method 1400 may include a step 1402 of providing a host platform. Further, the host platform manages at least one advertisement element. Further, the host platform uses at least one processing unit to execute computer-executable instructions stored on a non-transitory computer-readable medium. Further, the at least one advertisement element is associated with at least one display element, at least one audio element, and at least one haptic element.

Further, the method 1400 may include a step 1404 of providing a plurality of third-party social media platforms.

Further, the method 1400 may include a step 1406 of providing a host streamer profile managed by the host platform. Further, the host streamer profile may be associated with a streamer interface.

Further, the method 1400 may include a step 1408 of receiving at least one advertisement selection with the host platform from the host streamer profile.

Further, the method 1400 may include a step 1410 of designating at least one specific advertisement element from a plurality of advertisement elements based on the at least one advertisement selection.

Further, the method 1400 may include a step A 1412 of receiving input through the streamer interface of the host streamer profile to select at least one subordinate platform from the plurality of third-party social media platforms.

Further, the method 1400 may include a step B 1414 of initializing a real-time video feed associated with the host streamer profile on the host platform.

Further, the method 1400 may include a step C 1416 of simultaneously broadcasting the real-time video feed to each of the at least one subordinate platform. Further, the broadcasting of the real-time video feed may include multicasting, simulcasting, geo-casting, recasting, etc.

Further, the method 1400 may include a step D 1418 of outputting, by the host platform, the at least one specific advertisement element on the real-time video feed. Further, the at least one specific advertisement element may be outputted as an overlay on the real-time video feed. Further, the real-time video feed remains unchanged by the outputting of the at least one specific advertisement element. Further, the receiving of the at least one advertisement selection, and the designating of the at least one specific advertisement element may be sequentially performed at least one of before and during the simultaneously broadcasting of the real-time video feed. Further, the sequentially performing of the receiving of the at least one advertisement selection, and the designating of the at least one specific advertisement element may include sequentially executing of the receiving of the at least one advertisement selection, and the designating of the at least one specific advertisement element. Further, at least one of the real-time video feed and the at least one specific advertisement element may be a streaming media. Further, in an embodiment, steps (A) through (D) are sequentially executed. Further, the at least one specific advertisement element outputted on the real-time video feed, may be presented using a holographic display system. Further, the at least one specific advertisement element may include at least one holographic advertisement. Further, the at least one holographic advertisement may be projected in at least one of a virtual environment and a physical environment using one or more advanced holographic projectors of the holographic display system. Further, the at least one holographic advertisement be an interactive 3D advertisement element. Further, the holographic display system allows viewing the interactive 3D advertisement from multiple angles and interacting with the interactive 3D advertisement through one or more of hand gestures and speech of at least one of the plurality of users. Further, the holographic display system may employ ultrasonic haptics technology. Further, the holographic display system by employing the ultrasonic haptics technology provides tactile feedback, allowing at least one of the plurality of users to “feel” holographic objects comprised in the at least one advertisement element as at least one of the plurality of users interacts with the at least one specific advertisement element. For instance, a user could feel the texture of a product being advertised, enhancing engagement and creating a memorable experience. Further, the outputting of the at least one specific advertisement element on the real-time video feed may include simultaneously delivering the at least one specific advertisement element on the real-time video feed to a plurality of users on each of the at least one subordinate platform comprised of a plurality of platforms by employing quantum-enhanced cloud computing. Further, the quantum-enhanced cloud computing leverages quantum parallelism for encrusting real-time responsiveness and scalability for the simultaneously delivering of the at least one specific advertisement element.

Further, in some embodiments, the at least one specific advertisement element may be comprised of a plurality of contents. Further, the plurality of contents may be dynamically adjusted or customized. Further, the presenting of the at least one specific advertisement element may include presenting at least one of the plurality of contents based on at least one of an adjustment and a customization. Further, the at least one specific advertisement element may be associated with at least one characteristic. Further, the at least one characteristic may be dynamically adjusted or customized. Further, the at least one characteristic may include a brightness, a sound, an animation, a size, a haptic feedback, etc. Further, the at least one characteristic may correspond to at least one of the at least one display element, the at least one audio element, and the at least one haptic element. Further, the presenting of the at least one specific advertisement element as the overlay on the real-time video feed and the real-time video feed may include making the the at least one specific advertisement element viewable, audible, perceivable, feelable, etc. Further, the presenting of the at least one specific advertisement element as the overlay on the real-time video feed and the real-time video feed may include making the the at least one specific advertisement element sensable through a plurality of sensing channels. Further, the pluraliting of sensing channels may include seeing, hearing, touching, tasting, smelling, etc.

Further, in some embodiments, the at least one specific advertisement element may be characterized by at least one of a presentation characteristic and a duration. Further, the presentation characteristic may include at least one of a position, an orientation, a location, and a movement of the at least one specific advertisement element in relation to a frame of the real-time video feed. Further, the presentation characteristic may include a location, such as, but not limited to, a bottom, top, left, right, or center of a screen presenting the real-time video feed.

In further embodiments, the method 1400 of multi-platform social media advertising via digital overlays on real-time video feeds may include a step of determining at least one of a specific presentation characteristic and a specific duration for the at least one specific advertisement element in relation to the real-time video feed. Further, the outputting of the at least one specific advertisement element may be based on the determining of at least one of the specific presentation characteristic and the specific duration. Further, the at least one specific advertisement element may be outputted as the overlay with at least one of the specific presentation characteristic and the specific duration on the real-time video feed.

Further, in some embodiments, the real-time video feed and the at least one specific advertisement element as the overlay on the real-time video feed may be presented using at least one of a plurality of devices associated with the at least one subordinate platform based on the simultaneously broadcasting and the outputting. Further, the plurality of devices may include an advertisement device, a computing device, a wearable device, an extended reality device, a user device, a digital device, etc. Further, the plurality of devices may be used for interacting with the at least one subordinate platform. Further, the plurality of devices employs one or more quantum communication protocols. Further, the plurality of devices employing the one or more quantum communication protocols may be configured for synchronizing the presenting of the at least one specific advertisement element as the overlay on the real-time video feed. Further, the synchronizing of the presenting of the at least one specific advertisement element enables presenting of an identical content in real-time by the plurality of devices.

Further, in an embodiment, at least one of the plurality of devices may include at least one holographic display device. Further, the at least one holographic display device may include a holographic projector. Further, the at least one holographic display device may include an advertisement device, a holographic display system, etc. Further, the at least one specific advertisement element may include at least one holographic element. Further, the at least one holographic element may include a holographic imagery, a holographic representation, a hologram, a holographic object, a holographic component, a holographic image, etc. Further, the at least one holographic element may include at least one holographic content, at least one holographic advertisement, etc. Further, the presenting of the at least one specific advertisement element as the overlay on the real-time video feed may include displaying the at least one holographic element as the overlay on the real-time video feed. Further, in an embodiment, the at least one holographic display device may include one or more digital overhead holographic display devices. Further, the one or more digital overhead holographic display devices may be used to generate one or more holographic images. Further, the at least one specific advertisement element may be comprised of the one or more holographic images. For example, one or more devices (such as the at least one holographic display device) located on a street that displays a digital holographic image of a city’s speed limit. When a person drives towards the image, they will see the hologram display of the city’s speed limit or an Advertisement of local restaurant logo and/or commercial as a digital overlay.

Further, in an embodiment, the at least one holographic element may tactually be at least one of senses and interacts with at least one of an individual and an object using a reversed haptic technology. Further, the reversed haptic technology may be employed using at least one device (such as LIDAR sensors, ultrasonic waves emitter, sound waves generator, air pressure generator, etc.) and at least one programmable smart material. Further, the at least one device may include an advertisement device, Further, the individual may be a person, a human, a user, etc. Further, the object may include an item, an article, etc.

Further, in an embodiment, the at least one holographic element may tactually be at least one of interacted and sensed by at least one of the individual and the object. Further, the tactually at least one of the interacting and the sensing by at least one of the individual and the object may be based on the reversed haptic technology and a haptic technology. Further, the haptic technology may include an ultrasonic haptic technology. Further, at least one of the reversed haptic technology and the haptic technology may be employed by the at least one device. Further, the at least one device may include an advertisement device. Further, at least one of the plurality of devices may employ an ultrasonic haptics technology. Further, at least one of the plurality of devices employing the ultrasonic haptics technology may be configured for providing a tactile feedback to at least one of the plurality of users, allowing at least one of the plurality of users to “feel” one or more holographic objects comprised in the at least one specific advertisement element as at least one of the plurality of users interact with the at least one specific advertisement element. Further, at least one of the plurality of devices may include a holographic display system with ultrahaptics.

Further, in an embodiment, at least one of the plurality of devices may include at least one extended reality device. Further, the presenting of the at least one specific advertisement element as the overlay on the real-time video feed may include presenting the at least one specific advertisement element as the overlay on the real-time video feed in at least one extended reality environment. Further, the at least one extended reality environment may include a virtual reality environment, an augmented reality environment, a mixed reality environment, an extended reality environment, etc.

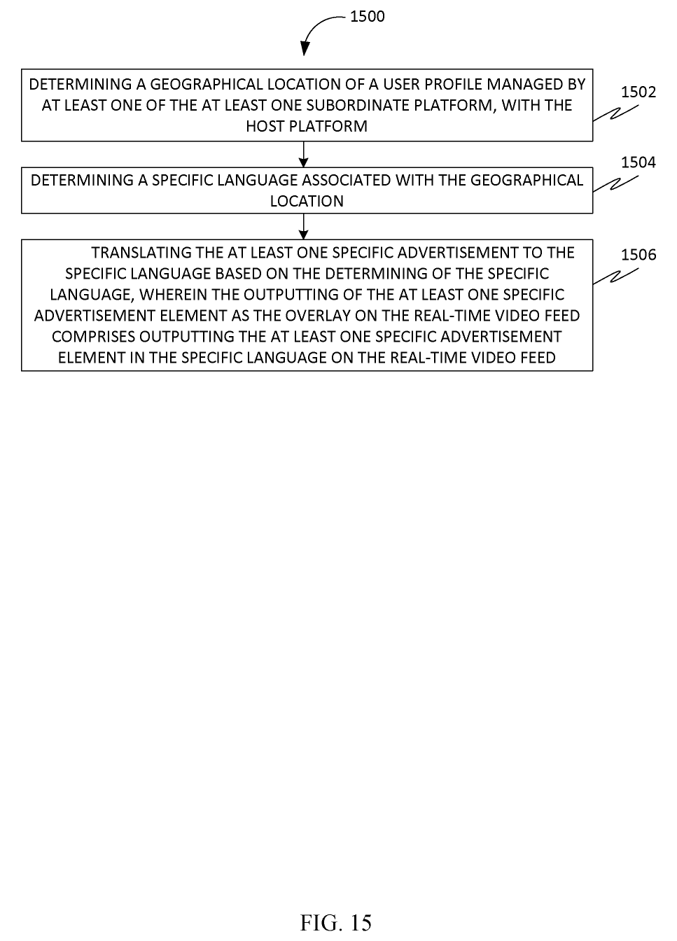

FIG. 15 is a flowchart of a method 1500 of multi-platform social media advertising via digital overlays on real-time video feeds, in accordance with some embodiments. Accordingly, the method 1500 may include a step 1502 of determining a geographical location of a user profile managed by at least one of the at least one subordinate platform, with the host platform. Further, the geographic location may location of a user associated with the user profile. Further, the user may be a viewer. Further, the determining of the geolocation may be based on a data from a geolocation sensor, a contextual data associated with the user profile, etc.

Further, the method 1500 may include a step 1504 of determining a specific language associated with the geographical location. Further, the specific language may include a natural language such as English, Hindi, Cantonese, French, Italian, Spanish, etc.

Further, the method 1500 may include a step 1506 of translating the at least one specific advertisement element to the specific language based on the determining of the specific language. Further, the outputting of the at least one specific advertisement element as the overlay on the real-time video feed may include outputting the at least one specific advertisement element in the specific language on the real-time video feed.

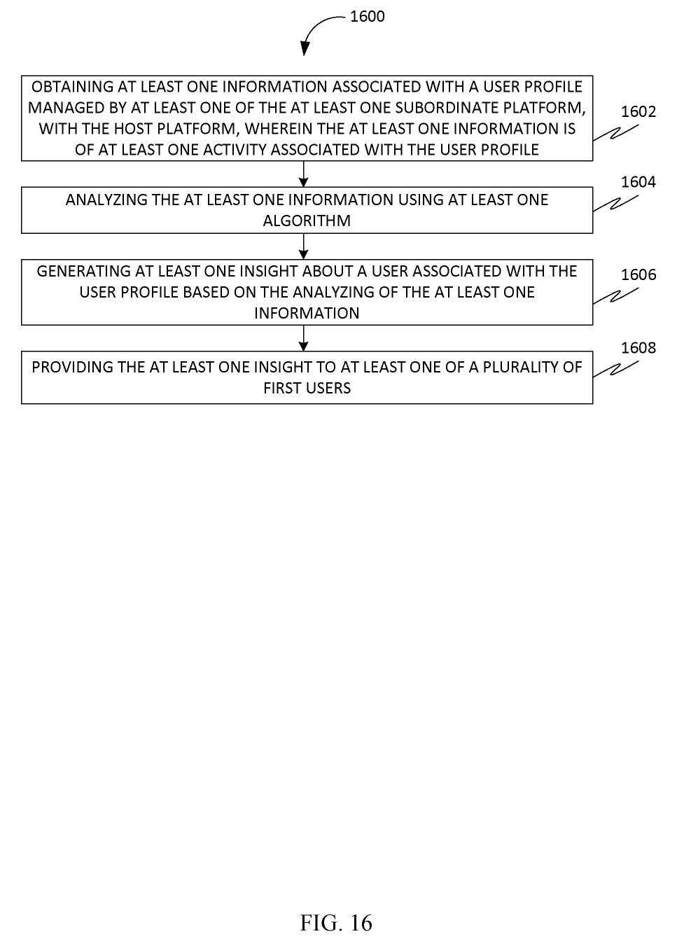

FIG. 16 is a flowchart of a method 1600 of multi-platform social media advertising via digital overlays on real-time video feeds, in accordance with some embodiments. Accordingly, the method 1600 may include a step 1602 of obtaining at least one information associated with a user profile managed by at least one of the at least one subordinate platform, with the host platform. Further, the at least one information may be of at least one activity associated with the user profile. Further, the at least one activity may include a social media activity, a purchasing activity, a media viewing activity, etc.

Further, the method 1600 may include a step 1604 of analyzing the at least one information using at least one algorithm. Further, the at least one algorithm may include a machine learning algorithm, an artificial intelligence algorithm, an analytic algorithm, etc.

Further, the method 1600 may include a step 1606 of generating at least one insight about a user associated with the user profile based on the analyzing of the at least one information. Further, the at least one insight may include a media viewing pattern, a geographic location, a demographic, a purchasing pattern, etc.

Further, the method 1600 may include a step 1608 of providing the at least one insight to at least one of a plurality of first users. Further, the plurality of first users may include advertisers, etc. Further, the providing of the at least one insight may include transmitting the at least one insight to at least one first device associated with at least one of the plurality of first users. Further, the at least one first user may include a computing device, a user device, a digital device, etc.

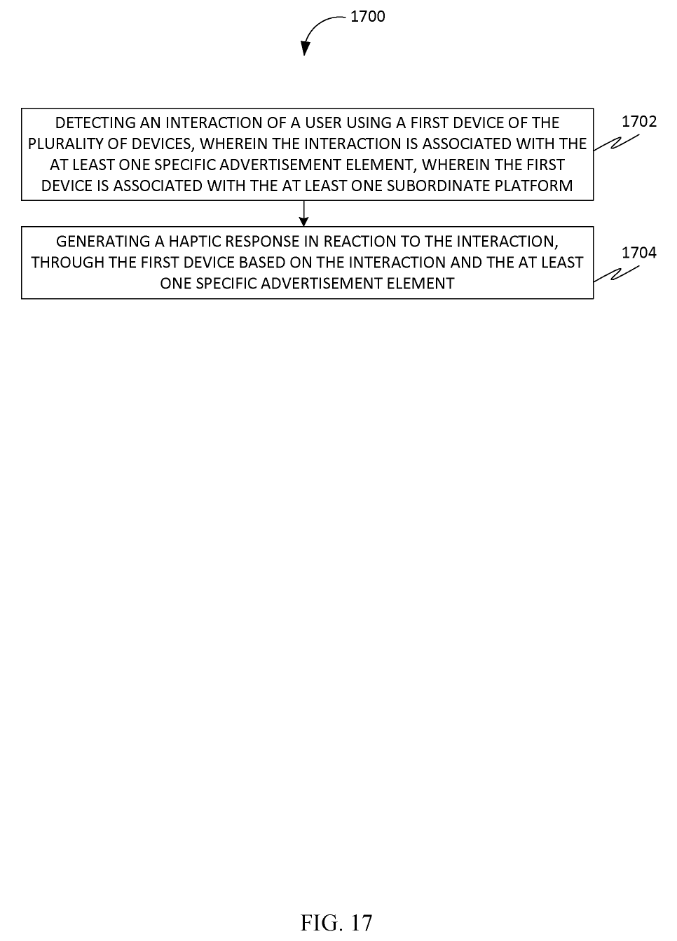

FIG. 17 is a flowchart of a method 1700 of multi-platform social media advertising via digital overlays on real-time video feeds, in accordance with some embodiments. Accordingly, the method 1700 may include a step 1702 of detecting an interaction of a user using a first device of the plurality of devices. Further, the plurality of devices may include computing devices, user devices, digital devices, etc. Further, the interaction may be for engagement with the at least one specific advertisement element. Further, the interaction may be associated with the at least one specific advertisement element. Further, the first device may be associated with the at least one subordinate platform.

Further, the method 1700 may include a step 1704 of generating a haptic response in reaction to the interaction, through the first device based on the interaction and the at least one specific advertisement element. Further, the haptic response may include a haptic reaction, a haptic sensation, a tactile sensation, a haptic feedback, etc.

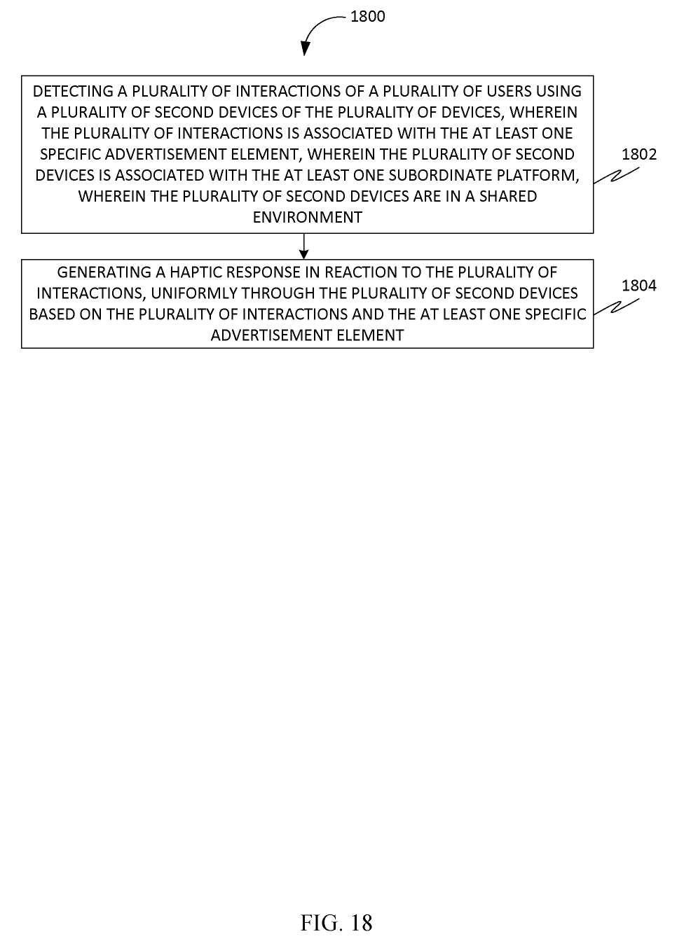

FIG. 18 is a flowchart of a method 1800 of multi-platform social media advertising via digital overlays on real-time video feeds, in accordance with some embodiments. Accordingly, the method 1800 may include a step 1802 of detecting a plurality of interactions of a plurality of users using a plurality of second devices of the plurality of devices. Further, the plurality of interactions may be associated with the at least one specific advertisement element. Further, the plurality of second devices may be associated with the at least one subordinate platform. Further, the plurality of second devices may be in a shared environment. Further, the shared environment implies at least one of the plurality of second devices and the plurality of users shares an environment. Further, the environment may include a physical environment, an extended reality environment, etc. Further, the environment may include a communication environment, a network environment, etc.

Further, the method 1800 may include a step 1804 of generating a haptic response in reaction to the plurality of interactions, uniformly through the plurality of second devices based on the plurality of interactions and the at least one specific advertisement element.

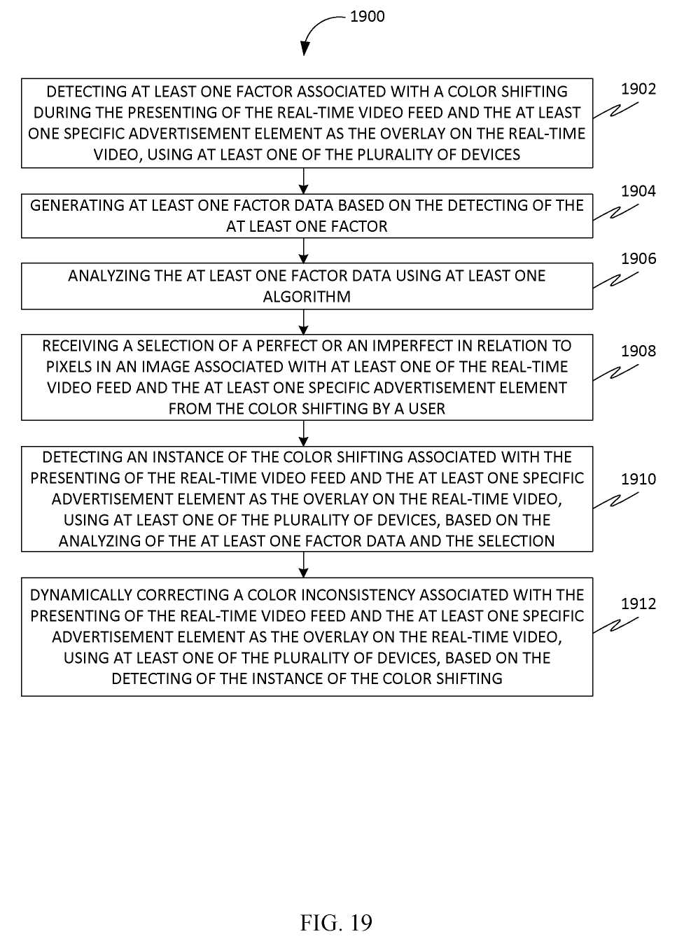

FIG. 19 is a flowchart of a method 1900 of multi-platform social media advertising via digital overlays on real-time video feeds, in accordance with some embodiments. Accordingly, the method 1900 may include a step 1902 of detecting at least one factor associated with a color shifting during the presenting of the real-time video feed and the at least one specific advertisement element as the overlay on the real-time video, using at least one of the plurality of devices. Further, the at least one factor corresponds to a display environment of at least one of the plurality of devices. Further, the at least one factor may be detected using at least one sensor. Further, the at least one sensor may include an environment sensor, a device sensor, a display sensor, etc., comprised and/or associated with at least one of the plurality of devices. Further, the at least one factor may include viewing angle, lighting conditions, subpixel misalignment, etc. Further, at least one of the plurality of devices may include a display screen (such as OLED screen, LCD screen, LED screen, QNED screen, QLED screen, etc.), a holographic projector, etc.

Further, the method 1900 may include a step 1904 of generating at least one factor data based on the detecting of the at least one factor.

Further, the method 1900 may include a step 1906 of analyzing the at least one factor data using at least one algorithm. Further, the at least one algorithm may include a machine learning algorithm, an artificial intelligence algorithm, an adaptive algorithm, etc.

Further, the method 1900 may include a step 1908 of receiving a selection of a perfect or an imperfect in relation to pixels in an image associated with at least one of the real-time video feed and the at least one specific advertisement element from the color shifting by a user.

Further, the method 1900 may include a step 1910 of detecting an instance of the color shifting associated with the presenting of the real-time video feed and the at least one specific advertisement element as the overlay on the real-time video, using at least one of the plurality of devices, based on the analyzing of the at least one factor data and the selection.

Further, the method 1900 may include a step 1912 of dynamically correcting a color inconsistency associated with the presenting of the real-time video feed and the at least one specific advertisement element as the overlay on the real-time video, using at least one of the plurality of devices, based on the detecting of the instance of the color shifting. Further, the dynamically correction may be performed in at least one of the plurality of devices.

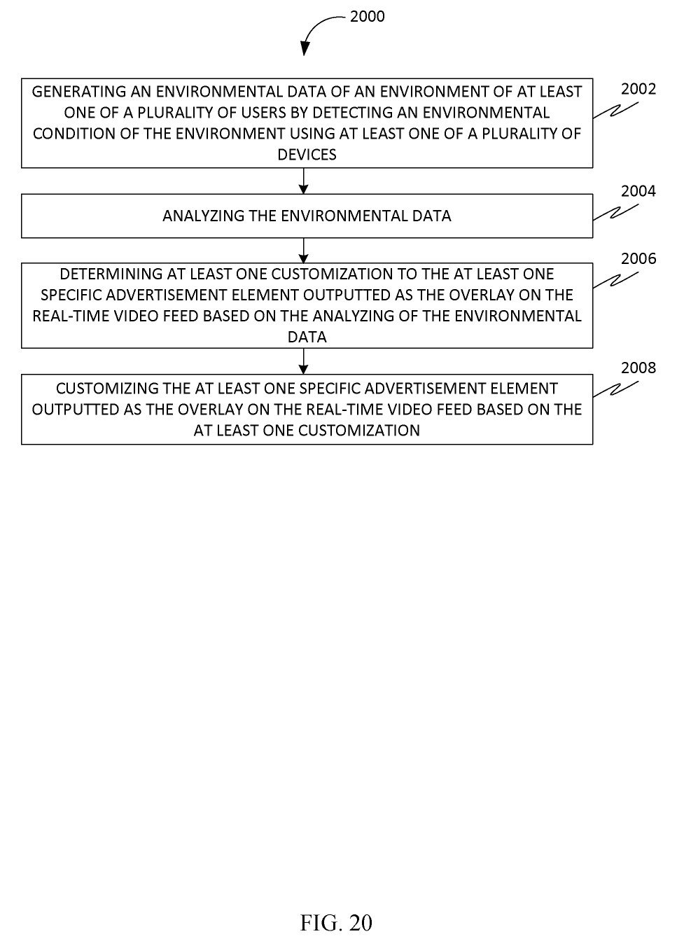

FIG. 20 is a flowchart of a method 2000 of multi-platform social media advertising via digital overlays on real-time video feeds, in accordance with some embodiments. Accordingly, the method 2000 may include a step 2002 of generating an environmental data of an environment of at least one of a plurality of users by detecting an environmental condition of the environment using at least one of a plurality of devices. Further, the environmental condition may include an ambient light, a crowd density, etc. Further, at least one of the plurality devices may include an environment sensor such as a lighting sensor, an imaging sensor, etc. Further, at least one of the plurality of devices may include at least one quantum sensor. Further, the environmental condition may include a real time environmental condition. Further, the detecting of the environmental condition may include detecting the environmental condition in real time.

Further, the method 2000 may include a step 2004 of analyzing the environmental data. Further, the analyzing of the environmental data may include analyzing the environmental data using a quantum computing device employing quantum computing, quantum processing, etc. Further, the quantum computing accelerates the processing of the environmental data, enabling delivering of the at least one specific advertisement element in real time. Further, the at least one specific advertisement element may be a personalized holographic content. Further, the analyzing of the environmental data may include analyzing the environmental data using one or more AI algorithms.

Further, the method 2000 may include a step 2006 of determining at least one customization to the at least one specific advertisement element outputted as the overlay on the real-time video feed based on the analyzing of the environmental data. Further, the at least one customization may be associated with a brightness, a size, a content, etc., of the at least one specific advertisement element.

Further, the method 2000 may include a step 2008 of customizing the at least one specific advertisement element outputted as the overlay on the real-time video feed based on the at least one customization. Further, the customizing of the at least one specific advertisement element may include adjusting the brightness, the size, the content, etc., of the at least one specific advertisement element. Further, the customizing of the at least one specific advertisement element adjusting the brightness, size, or content of the at least one specific advertisement element based on ambient light or crowd density to maximize visibility and relevance. Further, the customizing of the at least one specific advertisement element may perform context-aware holographic content delivery by tailoring the at least one specific advertisement element to a physical surrounding of at least one of a plurality of users.

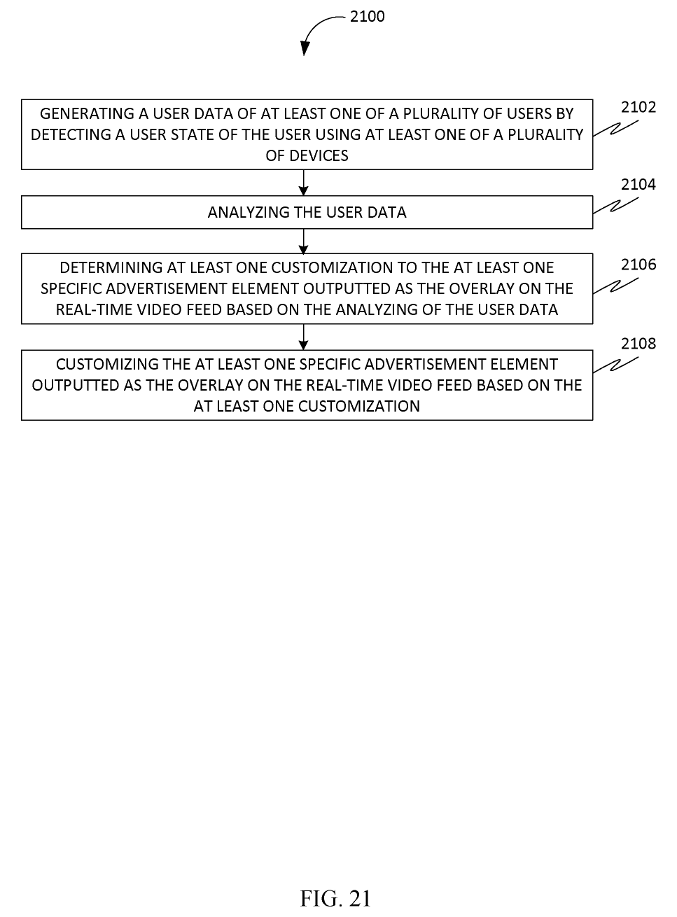

FIG. 21 is a flowchart of a method 2100 of multi-platform social media advertising via digital overlays on real-time video feeds, in accordance with some embodiments. Accordingly, the method 2100 may include a step 2102 of generating a user data of at least one of a plurality of users by detecting a user state of the user using at least one of a plurality of devices. Further, the user state may include a physical state (such as a movement, a gesture, a motion, a location, etc.), a physiological state (such as a heartbeat rate, a breathing rate, a blood pressure, a body temperature, etc.) an emotional state (such as a facial expression, an eye movement, a pupil dilation, an eye movement, a voice tone, etc.), etc. of the user. Further, at least one of the plurality of devices may include a physical state sensor, a physiological state sensor, an emotional state sensor, etc. Further, the physical state, the physiological state, the emotional state, etc. corresponds to a response and a reaction of at least one of the plurality of users consuming and/or interacting with the at least one specific advertisement element. Further, the generating of the user data may be based on one or more biometric sensors. Further, the one or more biometric sensors capture user-specific data, such as facial microexpressions, heart rate, and voice pitch of at least one of the plurality of users. Further, the one or more biometric sensors may include one or more quantum sensors. Further, the one or more quantum sensors provide ultra-sensitive detection capabilities, such as identifying microexpressions or subtle voice modulations. Further, the one or more quantum sensors enhance the precision of biometric data analysis, ensuring that advertisements respond accurately to a user input. Further, the user input corresponds to the user state, the user response, the user reaction, etc. Further, the user data may be encryptingly generated by employing quantum encryption. Further, the employing of the quantum encryption may include using one or more quantum encryption methods for encrypting the user data.

Further, the method 2100 may include a step 2104 of analyzing the user data. Further, the analyzing of the user data determines a preference, an emotion, an interest, etc. of the user. Further, the analyzing of the user data may include analyzing the user data using a quantum computing device employing quantum computing, quantum processing, etc. Further, the quantum computing accelerates the processing of the user data, enabling delivering of the at least one specific advertisement element in real time. Further, the at least one specific advertisement element may be a personalized holographic content.

Further, the method 2100 may include a step 2106 of determining at least one customization to the at least one specific advertisement element outputted as the overlay on the real-time video feed based on the analyzing of the user data.

Further, the method 2100 may include a step 2108 of customizing the at least one specific advertisement element outputted as the overlay on the real-time video feed based on the at least one customization. Further, the customizing may include tailoring the at least one specific advertisement element dynamically. Further, the tailoring of the at least one specific advertisement element may be performed in a real time feedback loop based on a continuous generation of the user data. Further, the real-time feedback loop ensures that the at least one specific advertisement element remains relevant and engaging, increasing the likelihood of user interaction and conversion.

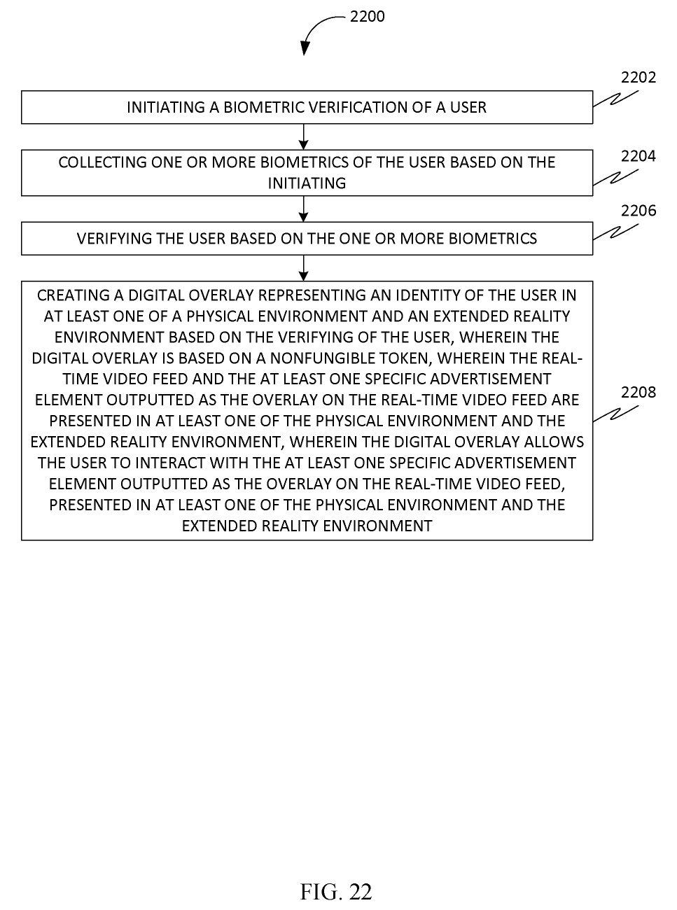

FIG. 22 is a flowchart of a method 2200 of multi-platform social media advertising via digital overlays on real-time video feeds, in accordance with some embodiments. Accordingly, the method 2200 may include a step 2202 of initiating a biometric verification of a user. Further, the initiating of the biometric verification may include initiating a biometric verification session for the biometric verification of the user.

Further, the method 2200 may include a step 2204 of collecting one or more biometrics of the user based on the initiating. Further, the one or more biometrics may be collected using one or more biometric sensors. Further, the one or more biometrics may include a heart rate, a voice tone, a facial expression, etc. of the user. Further, the collecting of the one or more biometrics may include receiving the one or more biometrics from the one or more biometric sensors. Further, the one or more biometrics generated by the one or more biometric sensors may be encrypted by employing quantum encryption. Further, the employing of the quantum encryption includes using one or more quantum encryption methods for encrypting the one or more biometrics. Further, the one or more biometrics may be received after the encryption of the one or more biometrics by employing the quantum encryption.

Further, the method 2200 may include a step 2206 of verifying the user based on the one or more biometrics.

Further, the method 2200 may include a step 2208 of creating a digital overlay representing an identity of the user in at least one of a physical environment and an extended reality environment based on the verifying of the user. Further, the digital overlay may be based on a nonfungible token. Further, the real-time video feed and the at least one specific advertisement element outputted as the overlay on the real-time video feed may be presented in at least one of the physical environment and the extended reality environment. Further, the digital overlay allows the user to interact with the at least one specific advertisement element outputted as the overlay on the real-time video feed, presented in at least one of the physical environment and the extended reality environment. Further, the digital overlay may include an advatar of the user. Further, the advatar may be in an image of the user. Further, the advatar may be an advertisement of user. Further, the at least one specific advertisement may include the advatar. Further, the advatar may be created using one or more advertisement devices. Further, the advatar may be a holographic imagery with haptics. Further, the advatar may perform one or more tasks based on a dense nature of increased pressure of air, sound, etc., associated with the advatar, and created using the one or more advertisement devices.

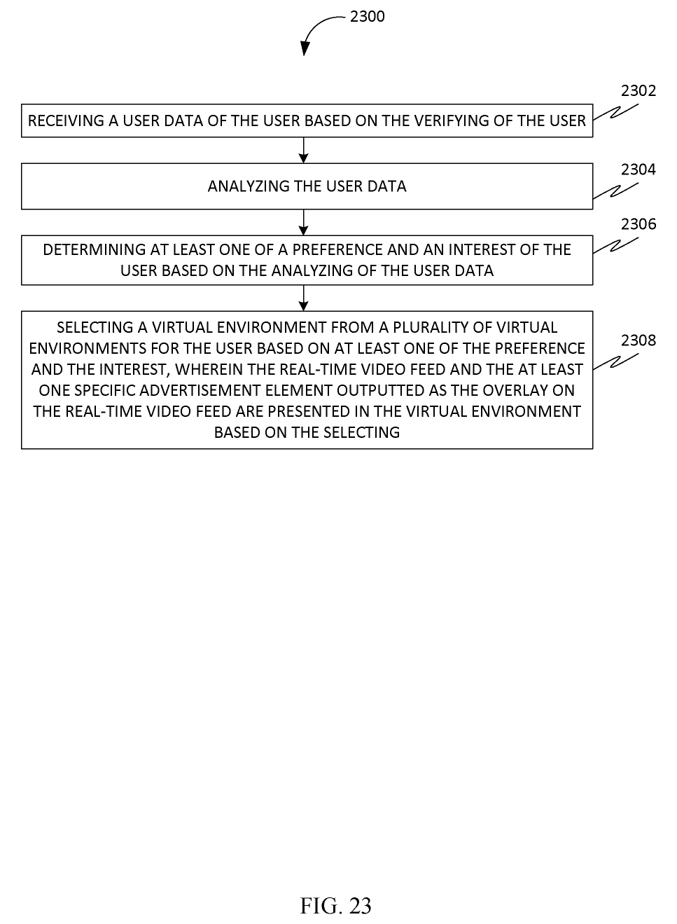

FIG. 23 is a flowchart of a method 2300 of multi-platform social media advertising via digital overlays on real-time video feeds, in accordance with some embodiments. Accordingly, the method 2300 may include a step 2302 of receiving a user data of the user based on the verifying of the user.

Further, the method 2300 may include a step 2304 of analyzing the user data.

Further, the method 2300 may include a step 2306 of determining at least one of a preference and an interest of the user based on the analyzing of the user data.

Further, the method 2300 may include a step 2308 of selecting a virtual environment from a plurality of virtual environments for the user based on at least one of the preference and the interest. Further, the virtual environment may include a chatroom. Further, the virtual environment aligns with at least one of the preference and the interest of the user. Further, the real-time video feed and the at least one specific advertisement element outputted as the overlay on the real-time video feed may be presented in the virtual environment based on the selecting.

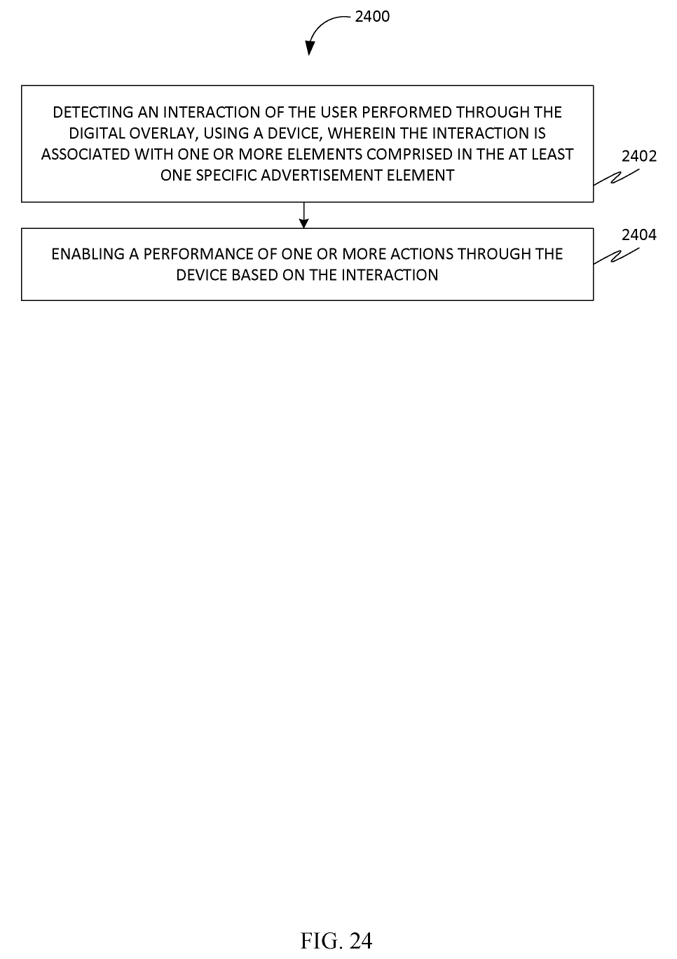

FIG. 24 is a flowchart of a method 2400 of multi-platform social media advertising via digital overlays on real-time video feeds, in accordance with some embodiments. Accordingly, the method 2400 may include a step 2402 of detecting an interaction of the user performed through the digital overlay, using a device. Further, the interaction may be associated with one or more elements comprised in the at least one specific advertisement element. Further, the interaction may be associated with at least one of the at least one specific advertisement element and one or more digital overlays. Further, the one or more elements may include one or more scannable elements. Further, the one or more elements may include dynamic QR codes, interactive hotspots, etc.

Further, the method 2400 may include a step 2404 of enabling a performance of one or more actions, through the device based on the interaction. Further, the enabling of the performance of the one or more actions may include performing of the one or more actions. Further, the one or more actions may include retrieving detailed information, completing transactions, sharing content, generating a haptic response in reaction to the interaction, etc. Further, the one or more actions may include a device-to-device interaction. Further, the device to device interaction may include allowing multiple users to collaboratively engage with the at least one specific advertisement element and/or share information between the device and at least one device securely.

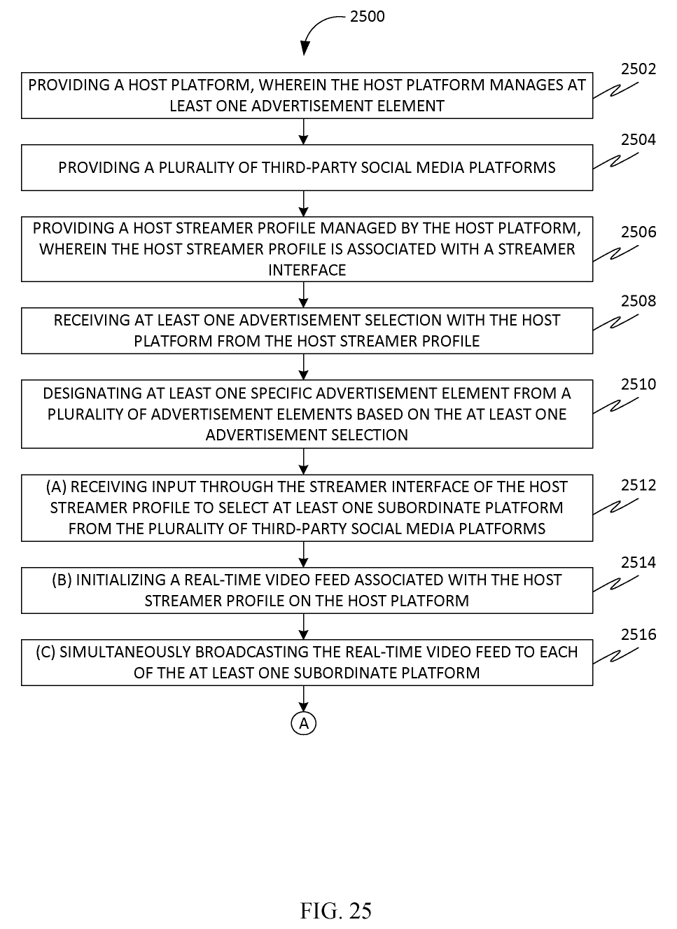

FIG. 25 is a flowchart of a method 2500 of multi-platform social media advertising via digital overlays on real-time video feeds, in accordance with some embodiments. Accordingly, the method 2500 may include a step 2502 of providing a host platform. Further, the host platform manages at least one advertisement element. Further, the host platform uses at least one processing unit to execute computer-executable instructions stored on a non-transitory computer-readable medium.

Further, the method 2500 may include a step 2504 of providing a plurality of third-party social media platforms.

Further, the method 2500 may include a step 2506 of providing a host streamer profile managed by the host platform. Further, the host streamer profile may be associated with a streamer interface.

Further, the method 2500 may include a step 2508 of receiving at least one advertisement selection with the host platform from the host streamer profile.

Further, the method 2500 may include a step 2510 of designating at least one specific advertisement element from a plurality of advertisement elements based on the at least one advertisement selection.

Further, the method 2500 may include a step A 2512 of receiving input through the streamer interface of the host streamer profile to select at least one subordinate platform from the plurality of third-party social media platforms.

Further, the method 2500 may include a step B 2514 of initializing a real-time video feed associated with the host streamer profile on the host platform.

Further, the method 2500 may include a step C 2516 of simultaneously broadcasting the real-time video feed to each of the at least one subordinate platform.

Further, the method 2500 may include a step D 2518 of outputting, by the host platform, the at least one specific advertisement element on the real-time video feed. Further, the at least one specific advertisement element may be outputted as an overlay on the real-time video feed. Further, the real-time video feed remains unchanged by the outputting of the at least one specific advertisement element. Further, the receiving of the at least one advertisement selection, and the designating of the at least one specific advertisement element may be sequentially performed at least one of before and during the simultaneously broadcasting of the real-time video feed.

Further, the method 2500 may include a step 2520 of determining a geographical location of a user profile managed by at least one of the at least one subordinate platform, with the host platform.

Further, the method 2500 may include a step 2522 of determining a specific language associated with the geographical location.

Further, the method 2500 may include a step 2524 of translating the at least one specific advertisement element to the specific language based on the determining of the specific language. Further, the outputting of the at least one specific advertisement element as the overlay on the real-time video feed may include outputting the at least one specific advertisement element in the specific language on the real-time video feed. Further, at least one of the real-time video feed and the at least one specific advertisement element may be a streaming media.

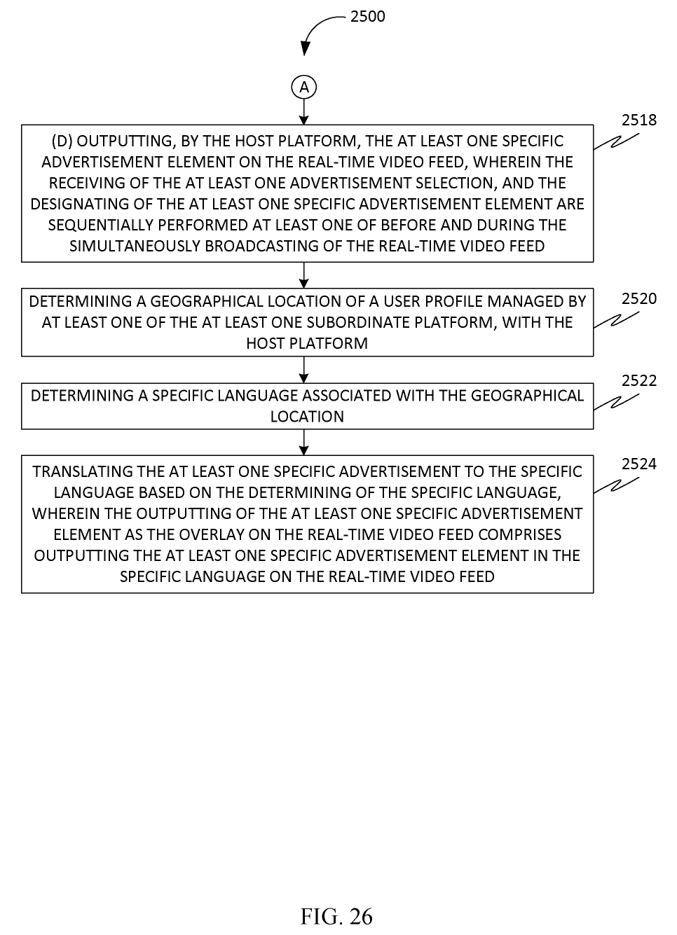

FIG. 26 is a continuation flowchart of the method 2500 of multi-platform social media advertising via digital overlays on real-time video feeds, in accordance with some embodiments.

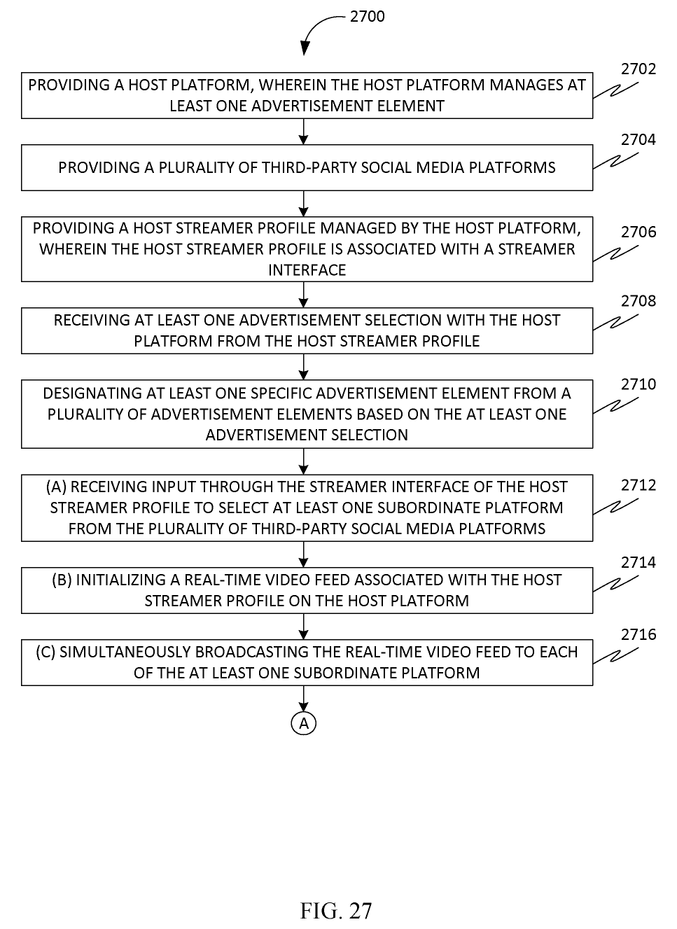

FIG. 27 is a flowchart of a method 2700 of multi-platform social media advertising via digital overlays on real-time video feeds, in accordance with some embodiments. Accordingly, the method 2700 may include a step 2702 of providing a host platform. Further, the host platform manages at least one advertisement element. Further, the host platform uses at least one processing unit to execute computer-executable instructions stored on a non-transitory computer-readable medium.

Further, the method 2700 may include a step 2704 of providing a plurality of third-party social media platforms.

Further, the method 2700 may include a step 2706 of providing a host streamer profile managed by the host platform. Further, the host streamer profile may be associated with a streamer interface.

Further, the method 2700 may include a step 2708 of receiving at least one advertisement selection with the host platform from the host streamer profile.

Further, the method 2700 may include a step 2710 of designating at least one specific advertisement element from a plurality of advertisement elements based on the at least one advertisement selection.

Further, the method 2700 may include a step A 2712 of receiving input through the streamer interface of the host streamer profile to select at least one subordinate platform from the plurality of third-party social media platforms.

Further, the method 2700 may include a step B 2714 of initializing a real-time video feed associated with the host streamer profile on the host platform.

Further, the method 2700 may include a step C 2716 of simultaneously broadcasting the real-time video feed to each of the at least one subordinate platform.

Further, the method 2700 may include a step D 2718 of outputting, by the host platform, the at least one specific advertisement element on the real-time video feed. Further, the at least one specific advertisement element may be outputted as an overlay on the real-time video feed. Further, the real-time video feed remains unchanged by the outputting of the at least one specific advertisement element. Further, the receiving of the at least one advertisement selection, and the designating of the at least one specific advertisement element may be sequentially performed at least one of before and during the simultaneously broadcasting of the real-time video feed.

Further, the method 2700 may include a step 2720 of obtaining at least one information associated with a user profile managed by at least one of the at least one subordinate platform, with the host platform. Further, the at least one information may be of at least one activity associated with the user profile.

Further, the method 2700 may include a step 2722 of analyzing the at least one information using at least one algorithm.

Further, the method 2700 may include a step 2724 of generating at least one insight about a user associated with the user profile based on the analyzing of the at least one information.

Further, the method 2700 may include a step 2726 of providing the at least one insight to at least one of a plurality of first users.

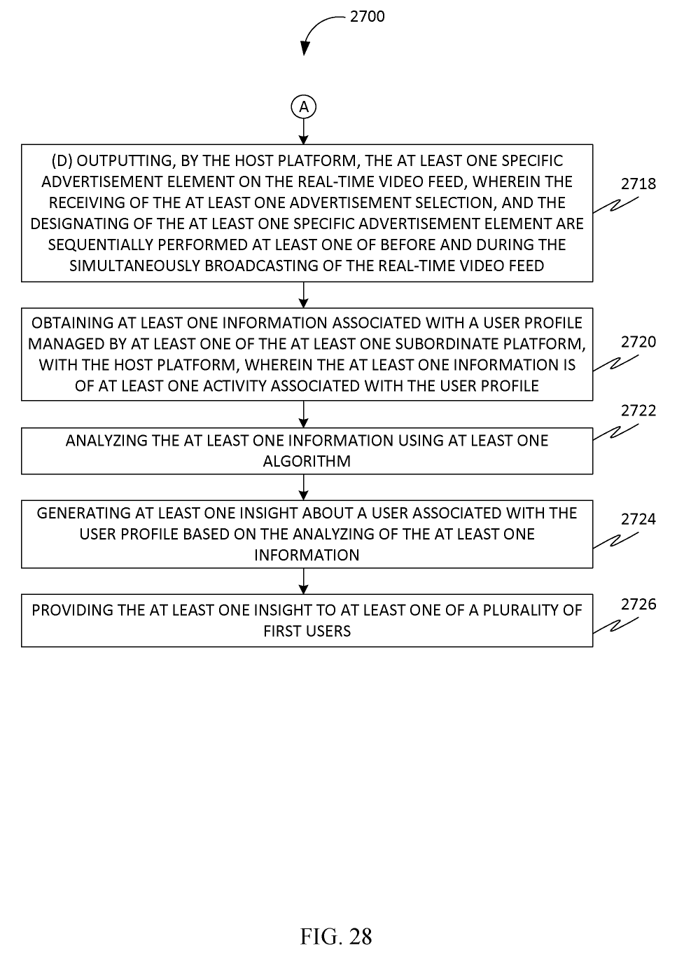

FIG. 28 is a continuation flowchart of the method 2700 of multi-platform social media advertising via digital overlays on real-time video feeds, in accordance with some embodiments.

According to some embodiments, a system for multi-platform social media advertising via digital overlays on real-time video feeds is disclosed. Further, the system may include a host platform. Further, the host platform may be configured for managing at least one advertisement element. Further, the host platform uses at least one processing unit to execute computer-executable instructions stored on a non-transitory computer-readable medium. Further, the host platform may be configured for providing a plurality of third-party social media platforms. Further, the host platform may be configured for providing a host streamer profile. Further, the host streamer profile may be managed by the host platform. Further, the host streamer profile may be associated with a streamer interface. Further, the host platform may be configured for receiving at least one advertisement selection from the host streamer profile. Further, the host platform may be configured for designating at least one specific advertisement element from a plurality of advertisement elements based on the at least one advertisement selection. Further, the host platform may be configured for (A) receiving input through the streamer interface of the host streamer profile to select at least one subordinate platform from the plurality of third-party social media platforms. Further, the host platform may be configured for (B) initializing a real-time video feed associated with the host streamer profile on the host platform. Further, the host platform may be configured for (C) simultaneously broadcasting the real-time video feed to each of the at least one subordinate platform. Further, the host platform may be configured for (D) outputting the at least one specific advertisement element on the real-time video feed. Further, the at least one specific advertisement element may be outputted as an overlay on the real-time video feed. Further, the real-time video feed remains unchanged by the outputting of the at least one specific advertisement element. Further, the receiving of the at least one advertisement selection and the designating of the at least one specific advertisement element are sequentially performed at least one of before and during the simultaneously broadcasting of the real-time video feed. Further, at least one of the real-time video feed and the at least one specific advertisement element may be a streaming media.

Further, in some embodiments, the host platform may be further configured for obtaining at least one information associated with a user profile managed by at least one of the at least one subordinate platform. Further, the at least one information may be of at least one activity associated with the user profile. Further, the host platform may be configured for analyzing the at least one information using at least one algorithm. Further, the host platform may be configured for generating at least one insight about a user associated with the user profile based on the analyzing of the at least one information. Further, the host platform may be configured for providing the at least one insight to at least one of a plurality of first users.

Further, in an embodiment, the real-time video feed and the at least one specific advertisement element as the overlay on the real-time video feed are presented using at least one of a plurality of devices associated with the at least one subordinate platform based on the simultaneously broadcasting and the outputting.

Further, in an embodiment, the host platform may be further configured for detecting an interaction of a user using a first device of the plurality of devices. Further, the interaction may be associated with the at least one specific advertisement element. Further, the first device may be associated with the at least one subordinate platform. Further, the host platform may be configured for generating a haptic response in reaction to the interaction, through the first device based on the interaction and the at least one specific advertisement element

Further, in an embodiment, at least one of the plurality of devices may include at least one holographic display device. Further, the at least one specific advertisement element may include at least one holographic element. Further, the presenting of the at least one specific advertisement element as the overlay on the real-time video feed may include displaying the at least one holographic element as the overlay on the real-time video feed. Further, the at least one holographic element may tactually be at least one of senses and interacts with at least one of an individual and an object using a reversed haptic technology. Further, the at least one holographic element may be tactually at least one of interacted and sensed by at least one of the individual and the object.

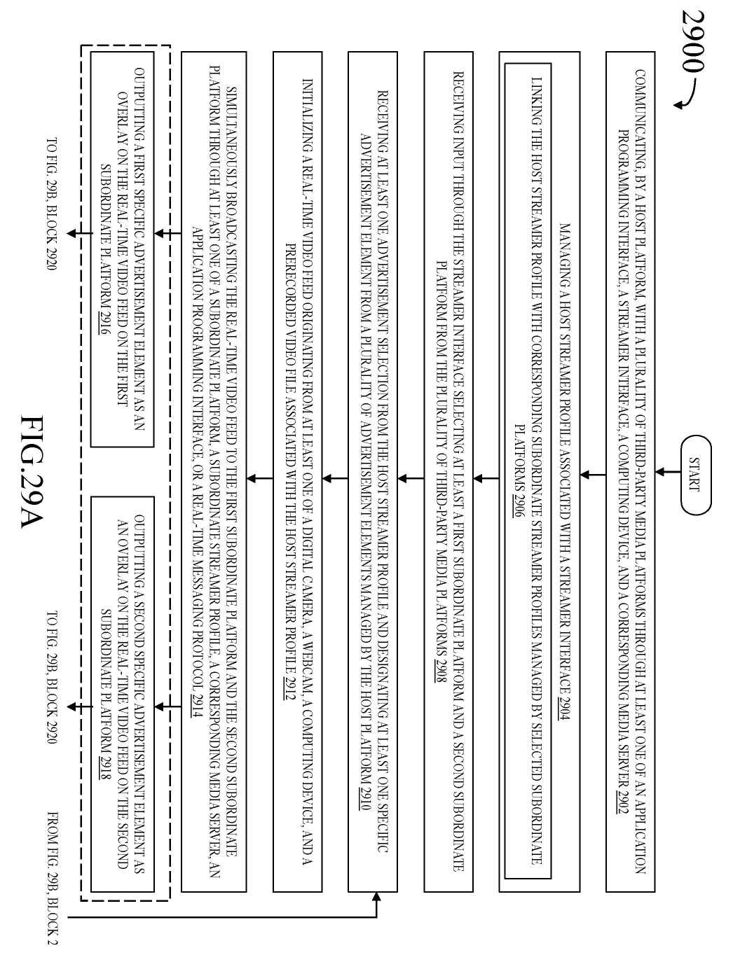

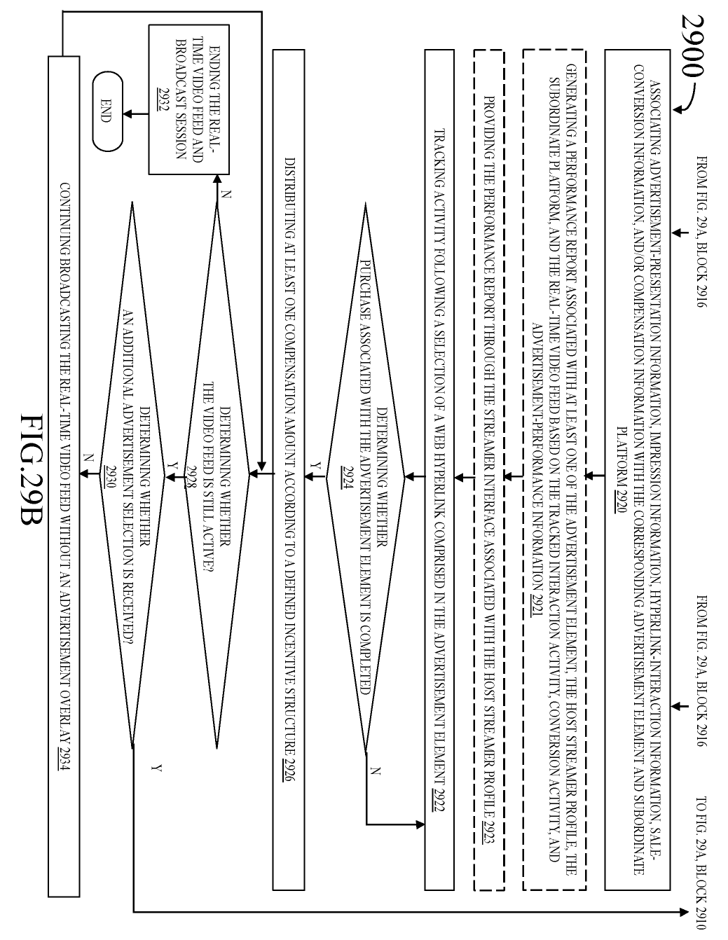

FIG. 29A is a flowchart illustrating a method of streamer-governed multi-platform advertising using digital overlays on real-time videos, according to some embodiments. FIG. 29B is a continuation flowchart of the method of FIG. 29A, according to some embodiments.

In some embodiments, a host platform communicates with a plurality of third-party media platforms through one or more application programming interfaces, streamer interfaces, computing devices, corresponding media servers, or other suitable communication means.

The host platform manages a host streamer profile associated with a streamer interface and receives input selecting at least a first subordinate platform and a second subordinate platform. The host streamer profile may be linked with corresponding subordinate streamer profiles managed by the selected subordinate platforms.

In some embodiments, the same host streamer profile provides both the advertisement direction, through the at least one advertisement selection, and the selection of participating subordinate platforms, through the input selecting the first subordinate platform and the second subordinate platform, such that streamer governance extends to both the advertisement content presented and the platforms through which the advertisement content is presented.

The host platform receives at least one advertisement selection from the host streamer profile and designates at least one specific advertisement element from a plurality of advertisement elements managed by the host platform.

A real-time video feed may originate from a digital camera, webcam, computing device, prerecorded or pre-edited video file, or another disclosed video-input source associated with the host streamer profile. A computing device may execute computer-executable instructions configured to receive the video content and communicate the same real-time video feed for presentation through the selected subordinate platforms.

The host platform initializes the real-time video feed and simultaneously broadcasts, or facilitates simultaneous broadcasting of, the real-time video feed to the first subordinate platform and the second subordinate platform.

The host platform outputs, or facilitates outputting of, at least one specific advertisement element as an overlay associated with presentation of the real-time video feed on at least one selected subordinate platform. The real-time video feed remains unchanged by the outputting of the advertisement element.

In some embodiments, a first specific advertisement element is presented with the real-time video feed on the first subordinate platform and a second specific advertisement element is presented with the same real-time video feed on the second subordinate platform. The first and second advertisement elements may differ according to geographical location, language, viewer-profile information, viewer activity, advertisement category, advertisement type, or information associated with a viewer profile managed by the corresponding subordinate platform.

The host platform may associate advertisement-presentation information, impression information, hyperlink-interaction information, sale-conversion information, and compensation information with the corresponding advertisement element and subordinate platform.

Where an advertisement element includes a web hyperlink, the host platform may track activity following selection of the hyperlink and determine whether a purchase associated with the advertisement element is completed.

Following presentation of the advertisement element, the host platform may distribute at least one compensation amount according to a defined incentive structure. The compensation amount may include a user portion, a host portion, and at least one third-party-platform portion.

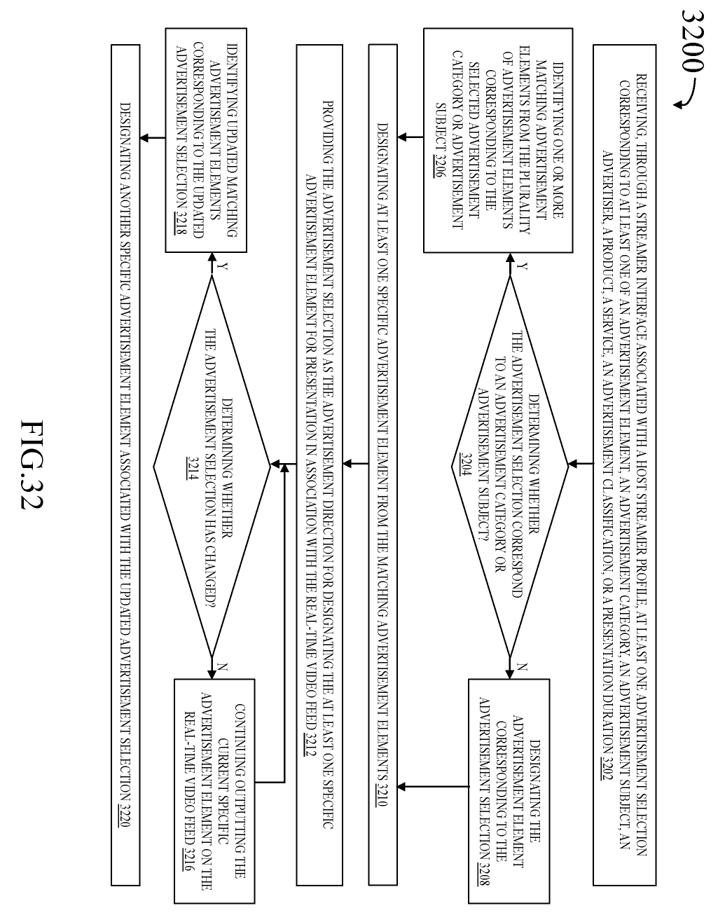

FIG. 32 is a flowchart illustrating a method of streamer-governed advertisement selection, according to some embodiments.

In some embodiments, a host platform manages a plurality of advertisement elements associated with a real-time video feed. The host platform receives, through a streamer interface associated with a host streamer profile, at least one advertisement selection corresponding to an advertisement element, advertisement category, advertisement subject, advertiser, product, service, advertisement classification, or presentation duration.

The advertisement selection received from the host streamer profile provides the advertisement direction used by the host platform in designating at least one specific advertisement element for presentation in association with the real-time video feed.

Where the host streamer profile selects an advertisement category or advertisement subject, the host platform identifies one or more matching advertisement elements corresponding to the selected category or subject and designates at least one specific advertisement element from the matching advertisement elements.

If the advertisement selection changes, the host platform may identify updated matching advertisement elements corresponding to the updated advertisement selection and designate another specific advertisement element associated with the updated advertisement selection.

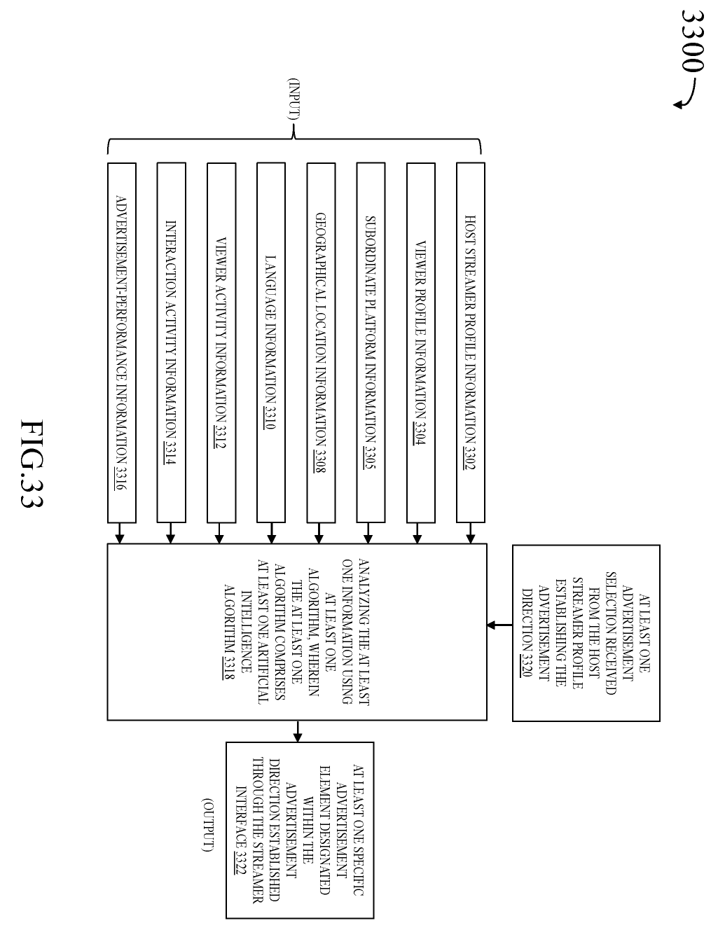

FIG. 33 is a block diagram illustrating algorithm-based designation of advertisement elements, according to some embodiments.

In some embodiments, the host platform analyzes information associated with the host streamer profile, a viewer profile, a subordinate platform, a geographical location, a language, activity associated with a viewer profile, interaction activity, or advertisement-performance information using at least one algorithm.

Based on the analyzed information and the advertisement selection associated with the host streamer profile, the host platform designates at least one specific advertisement element corresponding to the advertisement selection.

Generated information or insight associated with the viewer profile operates within the advertisement direction established through the streamer interface associated with the host streamer profile.

Returning to FIGS. 29A and 29B, in some embodiments, the host platform receives, through the streamer interface associated with the host streamer profile, input selecting a first subordinate platform and a second subordinate platform from a plurality of third-party media platforms.

The host platform initializes a real-time video feed associated with the host streamer profile and simultaneously broadcasts the real-time video feed to the first subordinate platform and the second subordinate platform.

A first specific advertisement element is output as an overlay associated with the real-time video feed on the first subordinate platform, and a second specific advertisement element is output as an overlay associated with the real-time video feed on the second subordinate platform.

The first specific advertisement element and the second specific advertisement element may differ while the real-time video feed remains unchanged by the outputting of the respective advertisement elements.

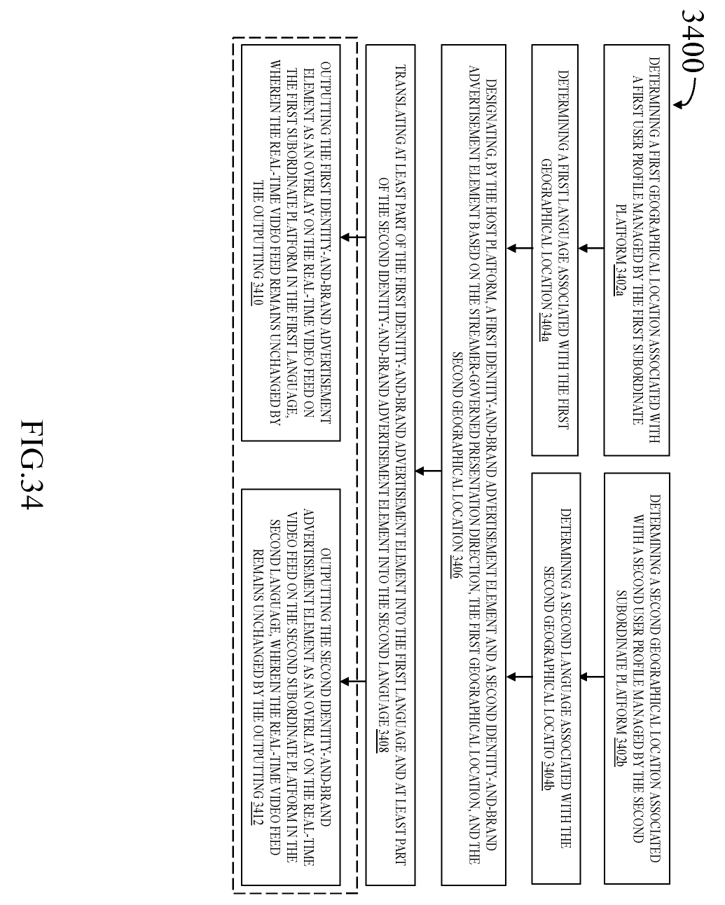

FIG. 34 is a flowchart illustrating a method of geographic and language-based translation and output of advertisement elements on real-time video feeds, according to some embodiments.

In some embodiments, the host platform determines a geographical location associated with a viewer profile managed by a subordinate platform and further determines a language associated with the geographical location.

The host platform may translate at least one specific advertisement element into the determined language and may output the translated advertisement element as an overlay associated with the real-time video feed.

A first translated advertisement element may be output on a first subordinate platform associated with a first geographical location, while a second translated advertisement element may be output on a second subordinate platform associated with a second geographical location, while the real-time video feed remains unchanged by the outputting of the translated advertisement elements.

In some embodiments, a host platform manages a host streamer profile associated with a streamer interface and a user-handle identifier. The user-handle identifier may correspond to a digital representation associated with the host streamer profile.

The host platform receives, through the streamer interface, input selecting a first subordinate platform and a second subordinate platform from a plurality of participating media platforms. The host platform further receives from the host streamer profile at least one advertisement selection, brand selection, personal-identity representation selection, or combination thereof.

The advertisement selection, brand selection, personal-identity representation selection, or combination thereof provides streamer-governed presentation direction for designating advertisement elements for presentation through the selected subordinate platforms.

The host platform determines a first geographical location associated with a first user profile managed by the first subordinate platform and determines a first language associated with the first geographical location. The host platform further determines a second geographical location associated with a second user profile managed by the second subordinate platform and determines a second language associated with the second geographical location.

Based on the streamer-governed presentation direction, the first geographical location, and the first language, the host platform designates a first identity-and-brand advertisement element for presentation through the first subordinate platform. Based on the streamer-governed presentation direction, the second geographical location, and the second language, the host platform designates a second identity-and-brand advertisement element for presentation through the second subordinate platform.

The host platform may translate at least part of the first identity-and-brand advertisement element into the first language and may translate at least part of the second identity-and-brand advertisement element into the second language.

The first identity-and-brand advertisement element and the second identity-and-brand advertisement element may each include a digital representation associated with the host streamer profile and at least one visual component associated with an advertiser, company, product, service, or brand message.

The digital representation may comprise a two-dimensional image, three-dimensional image, multidimensional image, still image, motion graphic, animated image, NFT content, avatar, anonymous avatar, webcam overlay, informational overlay, sponsor overlay, stream-label overlay, game overlay, talking-screen overlay, or another disclosed digital visual element.

In some embodiments, the digital representation comprises an NFT-based anonymous avatar associated with the host streamer profile. The anonymous avatar may be customized according to a user selection, interest, hobby, or platform involvement while preserving anonymity.

The host platform initializes a real-time video feed associated with the host streamer profile and simultaneously broadcasts the same real-time video feed to the first subordinate platform and the second subordinate platform.

The first identity-and-brand advertisement element is output as a first overlay associated with presentation of the real-time video feed through the first subordinate platform. The second identity-and-brand advertisement element is output as a second overlay associated with presentation of the same real-time video feed through the second subordinate platform.

The first identity-and-brand advertisement element and the second identity-and-brand advertisement element may differ according to geographical location, language, personal-identity representation, brand component, advertiser, product, service, or advertisement content.

The underlying real-time video feed remains unchanged between presentation through the first subordinate platform and presentation through the second subordinate platform notwithstanding the outputting of the first overlay and the second overlay. The outputting of the first overlay and the second overlay does not stop, pause, or break up the real-time video feed.

The host platform may associate impression information, hyperlink-interaction information, sale-conversion information, compensation information, or other disclosed advertisement activity with the corresponding identity-and-brand advertisement element and subordinate platform.

Following presentation of at least one of the first identity-and-brand advertisement element or the second identity-and-brand advertisement element, the host platform may distribute at least one compensation amount according to a defined incentive structure. The compensation amount may include a user portion associated with the host streamer profile, a host portion associated with the host platform, and at least one third-party-platform portion associated with a participating subordinate platform.

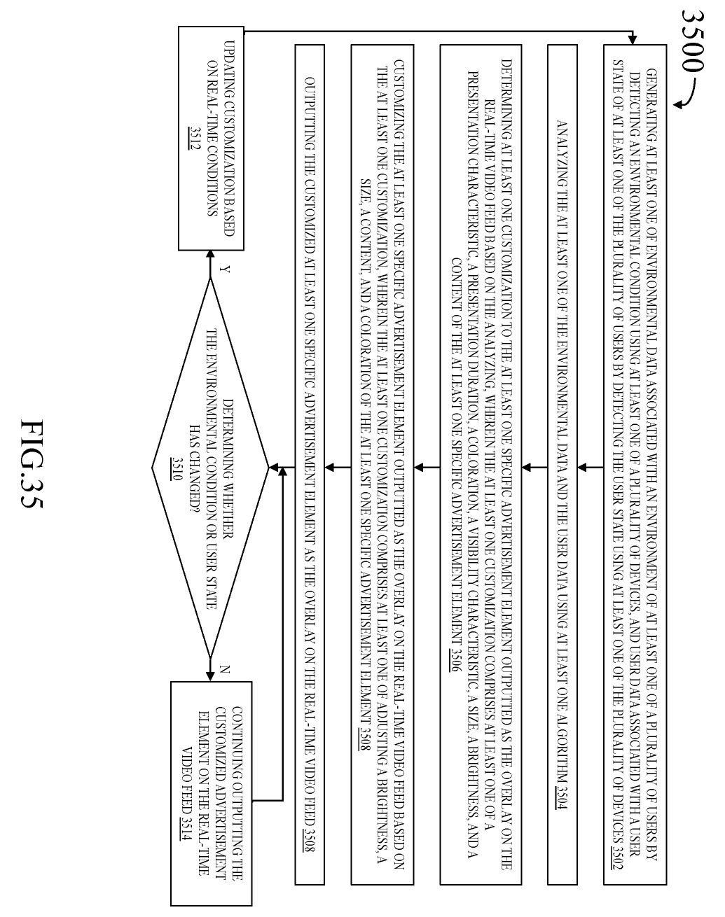

FIG. 35 is a flowchart illustrating a method of environmental and user-data driven customization of advertisement elements, according to some embodiments.

In some embodiments, the host platform generates environmental data associated with an environment or user data associated with a user state. The host platform analyzes at least one of the environmental data or the user data using at least one algorithm and determines customization associated with at least one advertisement element.

The customization may include a presentation characteristic, presentation duration, coloration, visibility characteristic, size, brightness, content, or another disclosed presentation characteristic associated with the advertisement element.

For example, the host platform may customize the advertisement element output as the overlay associated with the real-time video feed according to analyzed environmental data, analyzed user data, or another disclosed condition while the real-time video feed remains unchanged by the outputting of the advertisement element.

With reference to FIGS. 29A and 29B, in some embodiments, each selected subordinate platform is provided with a subordinate streamer profile, and a host streamer profile managed by the host platform is linked with each subordinate streamer profile.

The host streamer profile may be linked with each subordinate streamer profile through an application programming interface, Real-Time Messaging Protocol, or another suitable means for enabling communication between the host platform and each selected subordinate platform.

The host platform receives input through a streamer interface associated with the host streamer profile selecting at least a first subordinate platform and a second subordinate platform from a plurality of participating media platforms.

A real-time video feed associated with the host streamer profile is initialized on the host platform and simultaneously broadcast to the first subordinate platform and the second subordinate platform.

At least one specific advertisement element is output as an overlay associated with the real-time video feed in association with the subordinate streamer profile on each selected subordinate platform.

The real-time video feed remains unchanged by the outputting of the at least one specific advertisement element.

As illustrated in FIG. 29B, in some embodiments, the host platform tracks interaction activity associated with at least one advertisement element presented in association with the real-time video feed.

The tracked information may include impression information, click-through activity, interaction activity, conversion activity, sale conversions, subordinate-platform participation, or advertisement-performance information associated with the advertisement element.

The host platform may generate a performance report associated with the advertisement element, host streamer profile, subordinate platform, or real-time video feed.

The performance report may be provided through the streamer interface associated with the host streamer profile to assist the host streamer profile in evaluating advertisement performance.

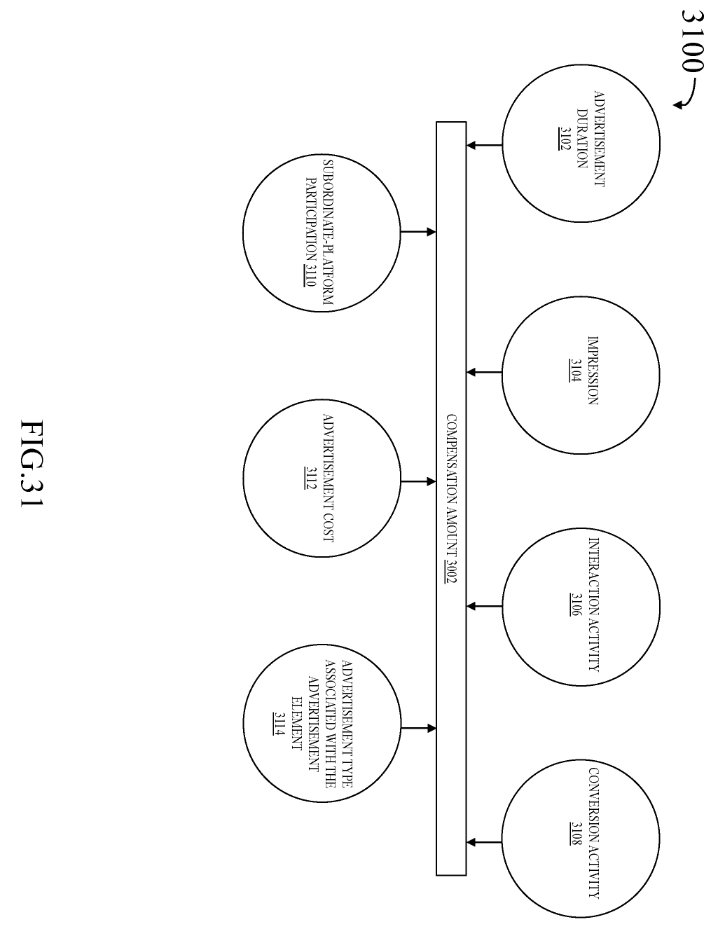

FIG. 31 is a block diagram illustrating exemplary factors associated with determining a compensation amount, according to some embodiments. As shown in FIG. 31, in some embodiments, each advertisement element is associated with at least one compensation amount.

The compensation amount may correspond to advertisement duration, impressions, interaction activity, conversion activity, subordinate-platform participation, advertisement cost, advertisement type, or another disclosed factor associated with presentation of the advertisement element.

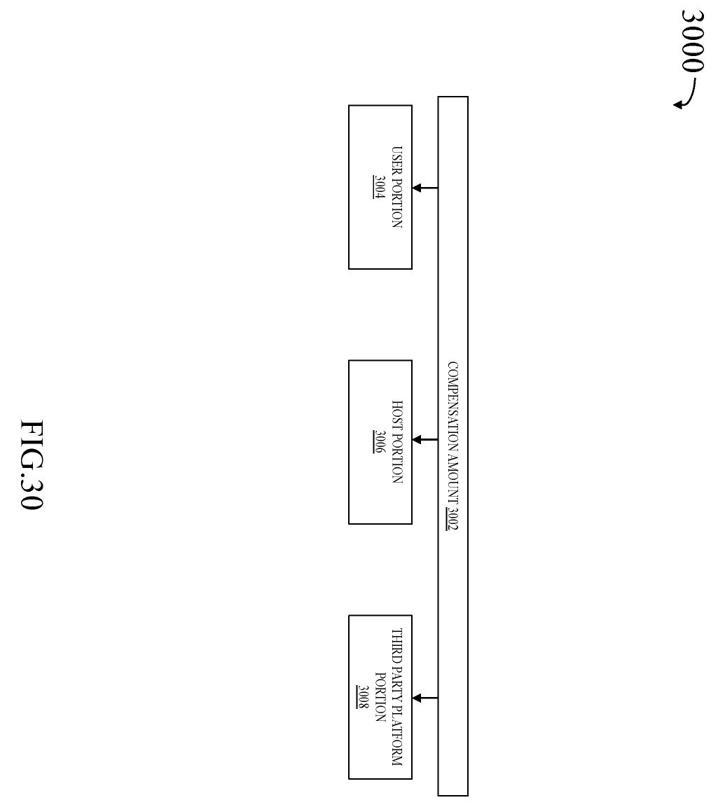

FIG. 30 is a block diagram illustrating an exemplary distribution of a compensation amount, according to some embodiments.

The compensation amount may comprise a user portion assigned to an account associated with the host streamer profile, a host portion assigned to the host platform, and at least one third-party-platform portion assigned to a corresponding subordinate platform participating in presentation of the advertisement element associated with the real-time video feed.

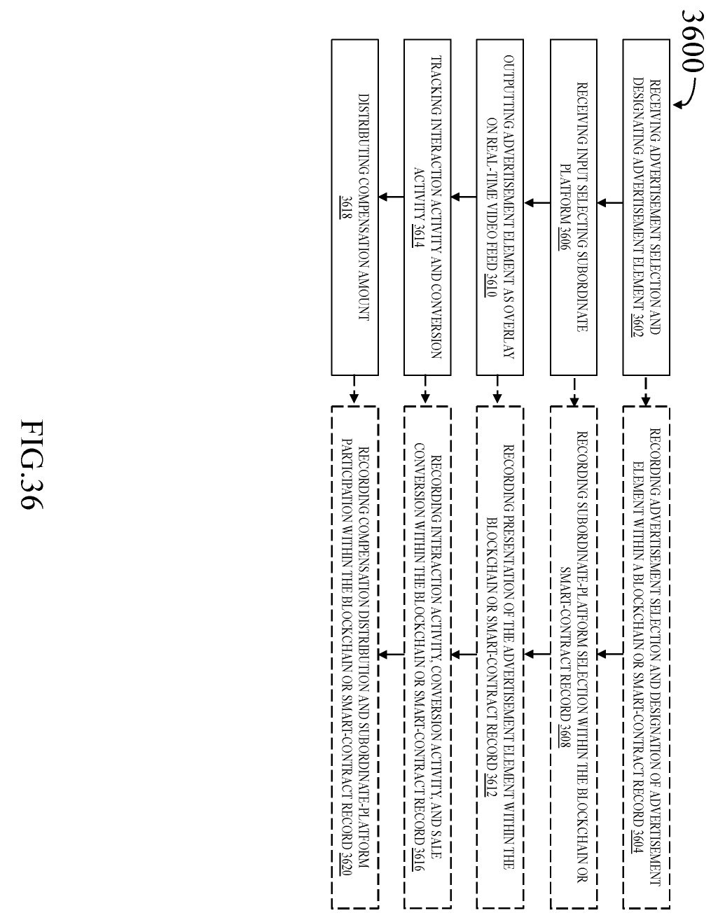

FIG. 36 is a block diagram illustrating blockchain and smart-contract recording of advertisement selection, presentation, interaction, and compensation distribution.

In some embodiments, the host platform records one or more stages of advertisement selection, advertisement designation, subordinate-platform selection, presentation of the advertisement element, interaction activity, conversion activity, sale conversion, compensation distribution, or subordinate-platform participation within a blockchain or smart-contract record associated with the advertisement element and the real-time video feed.

The blockchain or smart-contract functionality operates as an optional recordkeeping layer and does not alter the real-time video feed associated with presentation of the advertisement element as the overlay.

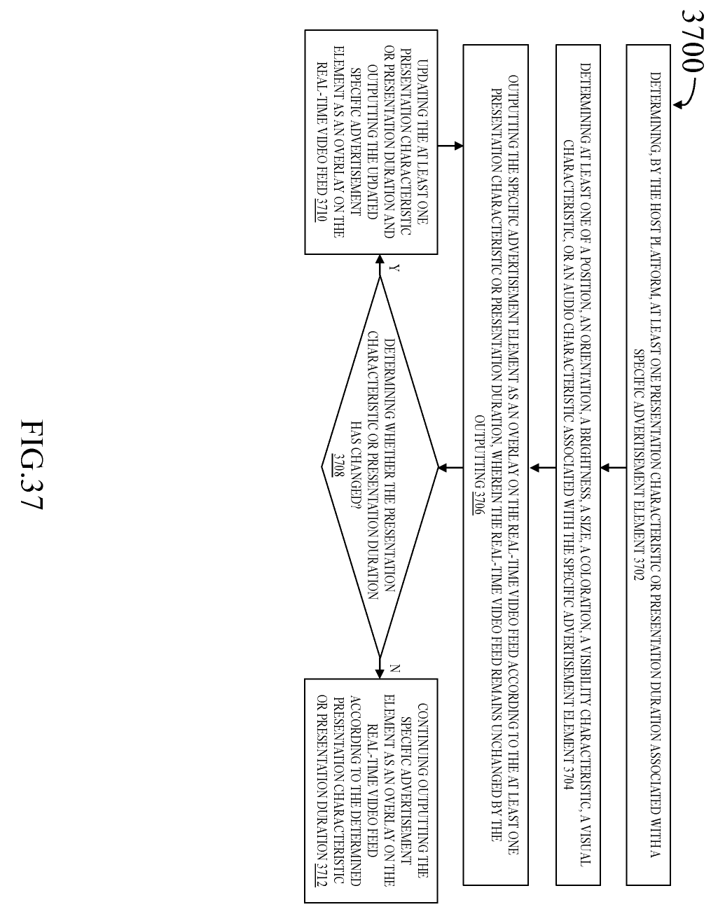

FIG. 37 is a flowchart illustrating a method of determining and applying presentation characteristics and duration to advertisement elements, according to some embodiments.

In some embodiments, the host platform determines at least one presentation characteristic or presentation duration for a specific advertisement element associated with the real-time video feed.

The presentation characteristic may include a position, orientation, location, brightness, size, coloration, visibility characteristic, visual characteristic, audio characteristic, or another disclosed manner in which the advertisement element is presented.

The host platform outputs the specific advertisement element as the overlay according to the determined presentation characteristic or presentation duration while the real-time video feed remains unchanged by the outputting of the advertisement element.

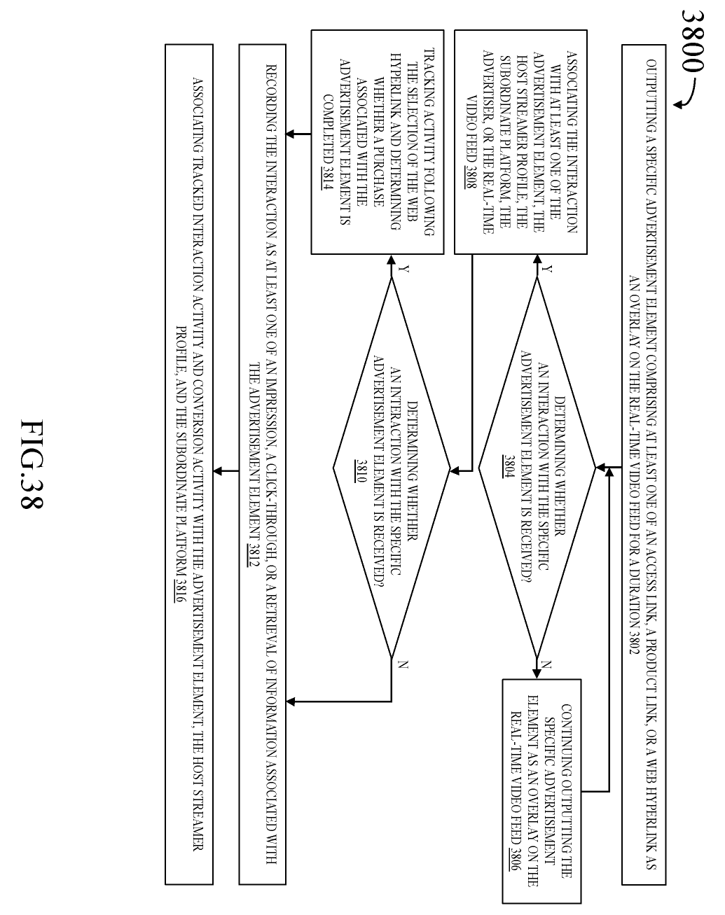

FIG. 38 is a flowchart illustrating a method of receiving, associating, and tracking interactions with advertisement elements, according to some embodiments.

In some embodiments, a specific advertisement element includes an access link, product link, web hyperlink, or another disclosed interactive component.

A viewer may interact with the advertisement element to retrieve information, access a product or service, initiate a transaction, or perform another disclosed action.

The host platform may associate the interaction with the advertisement element, host streamer profile, subordinate platform, advertiser, real-time video feed, or combination thereof.

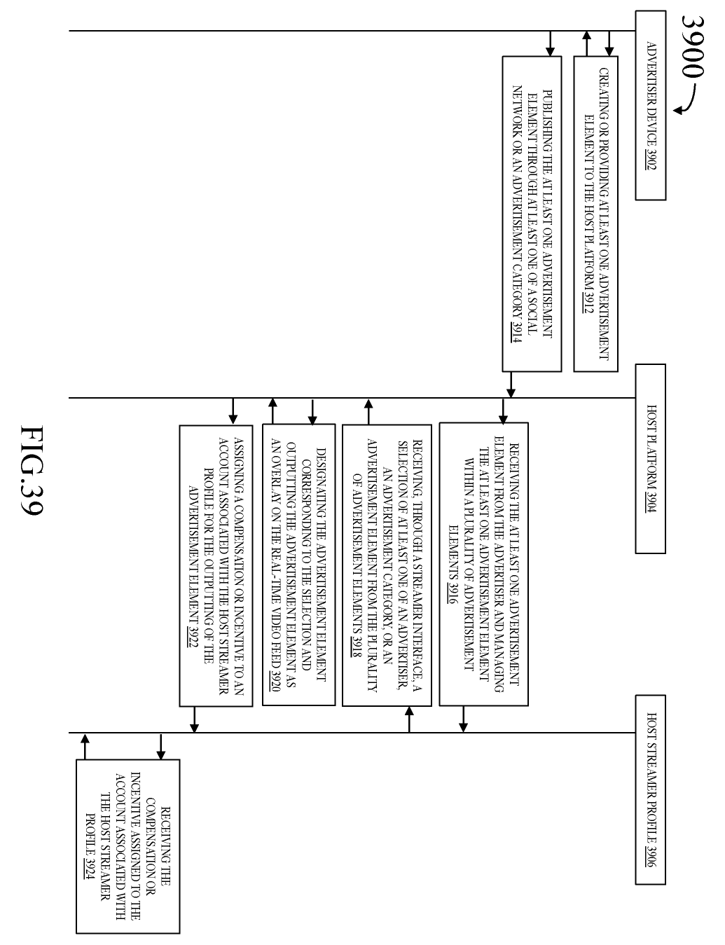

FIG. 39 is a time sequence diagram illustrating the sequence of advertiser creation, publication, and host-streamer selection of advertisement elements, according to some embodiments. The advertiser may be associated with an advertiser profile managed by the host platform, and the one or more advertisement elements provided by the advertiser are associated with the advertiser profile.

In some embodiments, an advertiser creates or provides one or more advertisement elements to the host platform.

The advertiser may publish or otherwise make the one or more advertisement elements available through a social network or according to one or more advertisement categories.

The host streamer profile may select an advertiser, advertisement category, or advertisement element through the streamer interface.

The host streamer profile may receive compensation or an incentive for presenting the selected advertisement element in association with the real-time video feed.

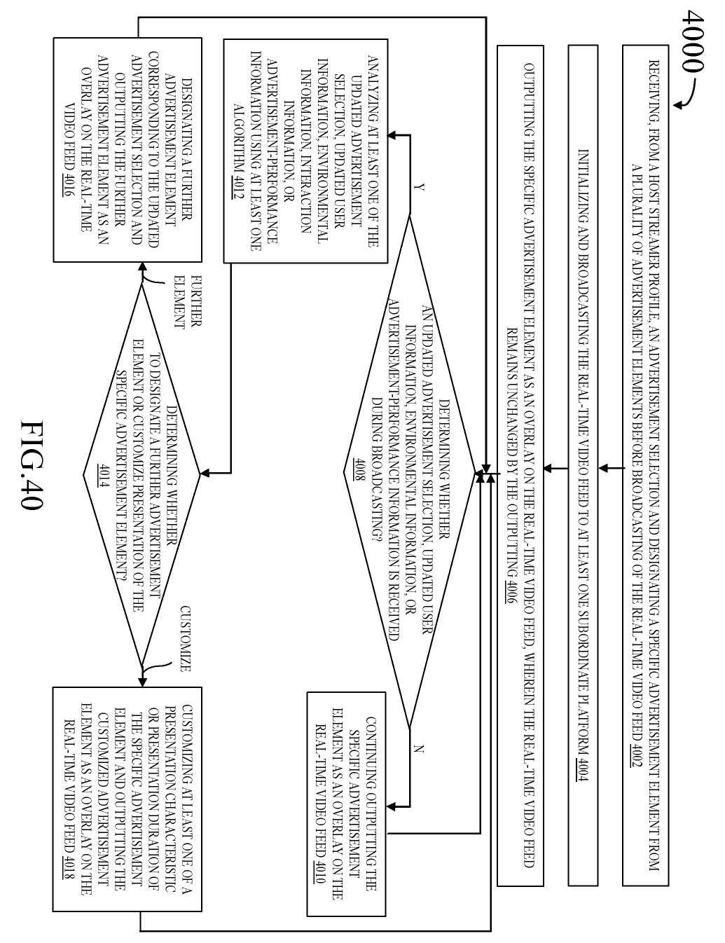

FIG. 40 is a flowchart illustrating a method of receiving and designating advertisement selections and further advertisement elements, according to some embodiments.

In some embodiments, receiving an advertisement selection and designating a specific advertisement element are sequentially performed before simultaneous broadcasting of the real-time video feed, during simultaneous broadcasting of the real-time video feed, or both before and during simultaneous broadcasting.

During simultaneous broadcasting, the host platform may receive an updated advertisement selection, analyze updated user information, analyze environmental information, analyze interaction or advertisement-performance information, or apply at least one algorithm.

The host platform may designate another specific advertisement element or customize the presentation of the specific advertisement element and may output the designated or customized advertisement element as an overlay associated with the real-time video feed. The change in the outputted advertisement element may be accomplished without stopping, pausing, breaking up, interrupting, replacing, regenerating, or reinitializing the real-time video feed, and the real-time video feed remains unchanged by the outputting of the designated or customized advertisement element.

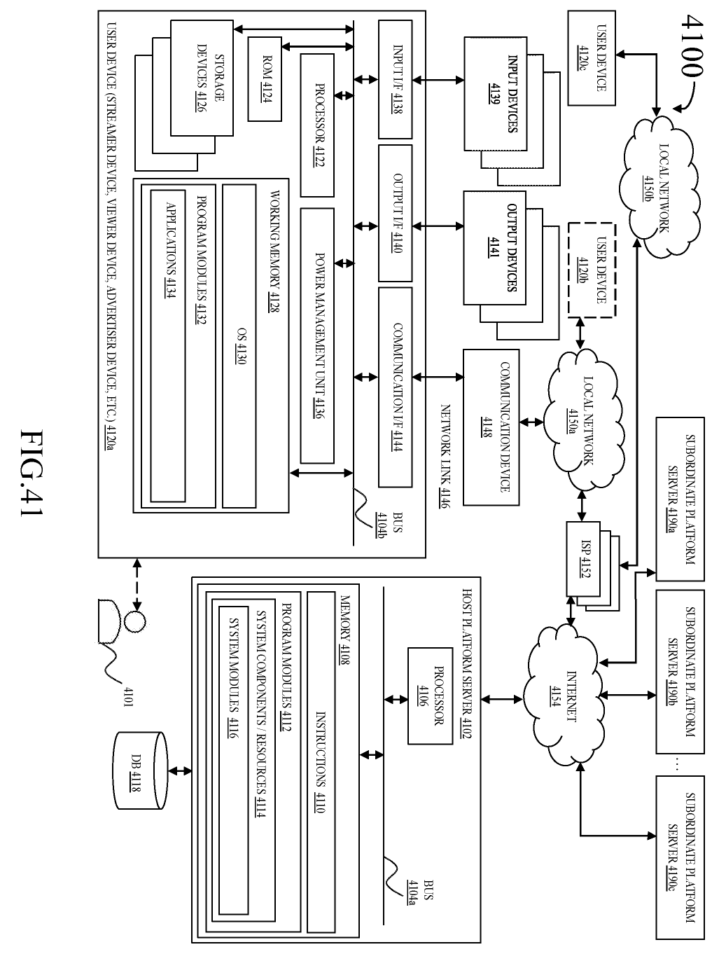

An exemplary operating environment for implementing various aspects of this disclosure is illustrated in FIG. 41. As illustrated in FIG. 41, an exemplary operating environment 4100 may include a computing device (e.g., user device 4120a, user device 4120b, and/or user device 4120c) in the form of a computer. In some embodiments, the computing device may be associated with a user 4101 (e.g., a streamer associated with a host streamer profile, a viewer associated with a viewer profile, an advertiser, etc.). Components of the user device 4120a may include, but are not limited to, various hardware components, such as a power management unit 4136, one or more processors 4122, storage devices 4126, working memory 4128, read-only memory (ROM) 4124, input devices 4139, output devices 4141, and a system bus 4104b that couples (e.g., communicably couples, physically couples, and/or electrically couples) various system components such that the components may transmit data to and from one another. The system bus 4104bmay be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 41, an operating environment 4100 for an exemplary embodiment includes at least one computing device, such as user device 4120a, user device 4120b, user device 4120c, host platform server 4102, and subordinate platform servers 4190a, 4190b, 4190c. The computing device 4120amay be a uniprocessor or multiprocessor computing device. An operating environment 4100 may include one or more computing devices in a given computer system, which may be clustered, part of a local network 4150a, 4150b, part of a wide area network (WAN), client-server networked, peer-to-peer networked within a cloud, or otherwise communicably linked. A computer system may include an individual machine or a group of cooperating machines. A given computing device may be configured for end-users, e.g., with applications 4134, for administrators, as a server (e.g., host platform server 4102, subordinate platform servers 4190a, 4190b, 4190c), as a distributed processing node, as a special-purpose processing device, or otherwise configured to manage a plurality of advertisement elements, initialize and broadcast real-time video feeds, output advertisement elements as overlays on real-time video feeds, and/or perform parallel multi-process execution.

One or more users 4101 may interact with the user device 4120aby using a display, keyboard, mouse, microphone, touchpad, camera (e.g., a digital camera or webcam originating a real-time video feed), sensor (e.g., touch sensor) and other input devices 4139 and output devices 4141, via typed text, touch, voice, movement, computer vision, gestures, and/or other forms of input/output. An input/output device 4139, 4141 may be removable (e.g., a connectable mouse or keyboard) or may be an integral part of the user device 4120a(e.g., a touchscreen, a built-in microphone). An input interface (I/F) 4138 and output interface (I/F) 4140 may support interaction between an embodiment and one or more users. A user interface may include one or more of a command line interface, a graphical user interface (GUI), natural user interface (NUI), voice command interface, and/or other user interface (UI) presentations, which may be presented as distinct options or may be integrated. In some embodiments, a streamer interface associated with a host streamer profile may be presented through such a user interface. A user 4101 may enter commands and information (e.g., an advertisement selection, a selection of at least one subordinate platform) through a user interface or other input devices 4139 such as a tablet, electronic digitizer, a microphone, keyboard, and/or pointing device, commonly referred to as mouse, trackball or touch pad. Other input devices 4139 may include a joystick, game pad, satellite dish, scanner, or the like. Additionally, voice inputs, gesture inputs using hands or fingers, or other NUI may also be used with the appropriate input devices, such as a microphone, camera, tablet, touch pad, glove, or other sensor. These and other input devices 4139 are often connected to the processor 4122 through an input I/F 4138 that is coupled to the system bus 4104b, but may be connected by other interface and bus structures, such as a parallel port, game port or a universal serial bus (USB). A monitor or other type of display device is also connected to the system bus 4104b via an output I/F 4140, such as a video interface. The monitor may also be integrated with a touch-screen panel or the like. Note that the monitor and/or touch screen panel can be physically coupled to a housing in which the computing device is incorporated, such as in a tablet-type personal computer. In addition, computers such as the user device 4120amay also include other peripheral output devices 4141 such as speakers and a printer, which may be connected through an output peripheral interface or the like.

One or more application programming interface (API) calls may be made between input devices 4139, output devices 4141, and computing devices (e.g., user device 4120a, host platform server 4102, subordinate platform servers 4190a, 4190b, 4190c), based on input received from an interface and/or from networks (e.g., local network 4150a, 4150b, ISP 4152, Internet 4154). As used throughout, “based on” may refer to being established or founded upon a use of, changed by, influenced by, caused by, or otherwise derived from. In some embodiments, an API call may be configured for a particular API, and may be interpreted and/or translated to an API call configured for a different API. As used herein, an API may refer to a defined (e.g., according to an API specification) interface or connection between computers or between computer programs. In some embodiments, communication between the host platform server 4102 and a subordinate platform server 4190a, 4190b, 4190c (e.g., for broadcasting a real-time video feed to a subordinate platform and/or outputting an advertisement element as an overlay on the real-time video feed) may be facilitated through one or more such API calls.

System administrators, network administrators, software developers, engineers, and end-users are each a particular type of user 4101. Automated agents, scripts, playback software, and the like acting on behalf of one or more people may also constitute a user 4101. Storage devices 4126, databases (e.g., DB 4118), and/or networking devices may be considered peripheral equipment in some embodiments and part of a system comprising one or more computing devices in other embodiments, depending on their detachability from the processor(s) 4122, 4106. Other computerized devices and/or systems not shown in FIG. 41 may interact in technological ways with user device 4120a or with another system using one or more connections to a network 4150a, 4150b, 4152, 4154 via a communication I/F 4144 and communication device 4148, which may include network interface equipment, such as a physical network interface controller (NIC) or a virtual network interface (VIF).

User device 4120a includes at least one logical processor 4122. The user device 4120a, like other suitable devices, also includes one or more computer-readable storage media, which may include, but are not limited to, working memory 4128, ROM 4124, and storage devices 4126. In some embodiments, working memory 4128 and storage devices 4126 may be part of a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium such as a portable (i.e., external) hard drive, compact disc (CD), Digital Versatile Disc (DVD), memory stick, or other removable non-volatile memory medium may become functionally a technological part of the computer system when inserted or otherwise installed with respect to one or more user devices 4120a, making its content accessible for interaction with and use by processor(s) 4122.

The configured medium may be configured with instructions (e.g., binary instructions, such as program modules 4132, applications 4134, instructions 4110) that are executable by a processor 4122, 4106; “executable” is used in a broad sense herein to include machine code, interpretable code, bytecode, compiled code, and/or any other code that is configured to run on a machine, including a physical machine or a virtualized computing instance (e.g., a virtual machine or a container). The configured medium may also be configured with data which is created by, modified by, referenced by, and/or otherwise used for technical effect by execution of the instructions. For example, such data may include a plurality of advertisement elements, a host streamer profile, a subordinate streamer profile, a viewer profile, advertisement-performance information, compensation information, and/or a blockchain record or smart-contract record. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processor(s) 4122, 4106 (e.g., one or more CPUs, ALUs, FPUs, and/or GPUs), working memory 4128, memory 4108, storage devices 4126, and screens/displays, an operating environment 4100 may also include other hardware, such as batteries, power management units 4136, buses 4104a, 4104b, power supplies, wired and wireless network interface cards, for instance. The nouns “screen” and “display” are used interchangeably herein. A display may include one or more touch screens, screens responsive to input from a pen or tablet, or screens which operate solely for output. In some embodiments, other input devices 4139 and output devices 4141 such as human user input/output devices (screen, keyboard, mouse, tablet, microphone, speaker, motion sensor, etc.) will be present in operable communication with one or more processors 4122 and working memory 4128.

In some embodiments, the system includes multiple computing devices connected by networks (e.g., local network 4150a, 4150b, ISP 4152, Internet 4154). Networking interface equipment can provide access to network(s) 4150a, 4150b, 4152, 4154 using components (which may be part of a communication I/F 4144) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches.

The user device 4120a may operate in a networked or cloud-computing environment using logical connections to one or more remote devices (e.g., using local network 4150a, 4150b, ISP 4152, Internet 4154), such as a remote computer (e.g., user device 4120b, user device 4120c, host platform server 4102, subordinate platform servers 4190a, 4190b, 4190c). The remote computer may include one or more of a personal computer, a server, a router, a network PC, or a peer device or other common network node, and may include any or all of the elements described above relative to the computer. The logical connections may include one or more LANs, WANs, and/or the Internet.

When used in a networked or cloud-computing environment, user device 4120a may be connected to a public or private network through a communication I/F 4144 or adapter. In some embodiments, a modem, communication device 4148, or other communication connection device may be used for establishing communications over the network via a network link 4146. The modem, which may be internal or external, may be connected to the system bus 4104bvia a network interface or other appropriate mechanism. A wireless networking component such as one comprising an interface and antenna may be coupled through a suitable device such as an access point or peer computer to a network. In a networked environment, program modules 4132 depicted relative to the computer, or portions thereof, may be stored in a remote memory storage device (e.g., DB 4118, memory 4108). It may be appreciated that the network connections shown are exemplary and other means of establishing a communications link between the computers may be used.

The user device 4120a typically may include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules 4132, or other data. Computer storage media includes, but is not limited to, RAM (e.g., working memory 4128), ROM 4124, electrically erasable programmable read-only memory (EEPROM), flash memory or other memory technology, CD-ROM, DVD or other optical disk storage, magnetic cassettes, magnetic tape, magnetic disk storage or other storage devices 4126, or any other medium which can be used to store the desired information (e.g., program modules 4132, OS 4130, applications 4134) and which can be accessed by the computer. Communication media may embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of the any of the above may also be included within the scope of computer-readable media. Computer-readable media may be embodied as a computer program product, such as software (e.g., including program modules 4132) stored on non-transitory computer-readable storage media.

The storage devices 4126 or system memory includes computer storage media in the form of volatile and/or nonvolatile memory such as ROM 4124 and RAM (e.g., working memory 4128). A basic input/output system (BIOS), containing the basic routines that help to transfer information between elements within the computer, such as during start-up, may be stored in ROM 4124. Working memory 4128 may contain data and/or program modules 4132 that are immediately accessible to and/or presently being operated on by processor 4122. By way of example, and not limitation, working memory 4128 holds an operating system (OS) 4130, applications 4134, and other program modules 4132 and program data. Storage devices 4126 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

Exemplary disclosed embodiments include systems, methods, and computer-readable media for presenting an advertisement element as an overlay on a real-time video feed broadcast to a plurality of third-party media platforms. For example, in some embodiments, and as illustrated in FIG. 41, an operating environment 4100 may include at least one computing device 4120a, the at least one computing device 4120a including at least one processor 4122, at least one memory (e.g., working memory 4128, ROM 4124), at least one data storage (e.g., storage devices 4126), and/or any other component discussed below, such as with respect to FIG. 41. Further, the operating environment 4100 may include a host platform server 4102 (comprising a processor 4106, memory 4108, instructions 4110, program modules 4112, system components / resources 4114, and system modules 4116) and one or more subordinate platform servers 4190a, 4190b, 4190c configured to cooperatively communicate via networks 4150a, 4150b, 4152, 4154 and utilize a shared database 4118 to receive an advertisement selection from a host streamer profile, designate an advertisement element from a plurality of advertisement elements, initialize and broadcast a real-time video feed to at least one subordinate platform, and output the advertisement element as an overlay on the real-time video feed, wherein the real-time video feed remains unchanged by the outputting. In some embodiments, the user device 4120amay operate as a streamer device associated with the host streamer profile from which the real-time video feed originates, a viewer device associated with a viewer profile managed by a subordinate platform through which the real-time video feed and the overlaid advertisement element are presented, an advertiser device through which an advertiser creates or provides one or more advertisement elements to the host platform server 4102, or any combination thereof.

### EXAMPLES

For example, a host streamer profile selects, through the streamer interface, a first subordinate platform and a second subordinate platform, and further selects an advertisement category. The host platform designates a first specific advertisement element corresponding to the advertisement category for the first subordinate platform and a second specific advertisement element corresponding to the advertisement category for the second subordinate platform. The same real-time video feed is simultaneously broadcast to the first subordinate platform and the second subordinate platform, the first specific advertisement element is output as an overlay on the first subordinate platform, the second specific advertisement element is output as an overlay on the second subordinate platform, and interaction activity and compensation information are recorded in association with the corresponding advertisement element and subordinate platform.

To illustrate another example, a first user profile managed by the first subordinate platform is associated with a first geographical location corresponding to Italy and a first language corresponding to Italian, and a second user profile managed by the second subordinate platform is associated with a second geographical location corresponding to the United States and a second language corresponding to English. A first translated advertisement element in Italian is output as an overlay on the real-time video feed on the first subordinate platform and a second translated advertisement element in English is output as an overlay on the same real-time video feed on the second subordinate platform.

For another example, the host streamer profile selects, through the streamer interface, an anonymous identity representation and a brand element. A first localized identity-and-brand advertisement element is output as an overlay through the first subordinate platform and a second, different localized identity-and-brand advertisement element is output as an overlay through the second subordinate platform, while the same underlying real-time video feed continues on both subordinate platforms.

For another example, initial platform-specific overlays are output on the first subordinate platform and the second subordinate platform. During the simultaneous broadcasting, the host streamer profile changes the advertisement selection through the streamer interface, and the host platform designates and outputs a changed overlay on at least one of the first subordinate platform or the second subordinate platform, while the underlying real-time video feed continues without reinitialization or interruption.

### DEFINITIONS

As used herein, an “underlying real-time video feed” or “real-time video feed” refers to the continuing source video content associated with the host streamer profile, distinct from any advertisement element, identity representation, brand element, or other supplemental overlay presented in association with the source video content.

As used herein, “streamer governance” refers to receiving input from a host streamer profile that determines at least one of an advertisement direction or a selection of participating subordinate platforms, followed by host-platform operations carried out according to the received input.

As used herein, a “platform-specific overlay” refers to an overlay designated for presentation in correspondence with a particular selected subordinate platform or a subordinate streamer profile managed by the particular selected subordinate platform.

As used herein, a real-time video feed “remains unchanged” by an outputting of an overlay where a difference between presentations on respective subordinate platforms results from the respective platform-specific overlays rather than from replacing, interrupting, segmenting, or generating different underlying source-feed content for the respective subordinate platforms.

The foregoing detailed description is exemplary and explanatory and is not intended to limit the scope of the present disclosure. The description is intended to enable those skilled in art to make and use the disclosed embodiments and is not intended to limit their scope, applicability, or configuration. The accompanying drawings, which are incorporated in and constitute a part of this specification, illustrate exemplary embodiments and, together with the description, explain their principles. Elements in the drawings may be exaggerated for clarity. Well-known methods, components, and techniques are not described in detail so as not to obscure the present disclosure. Although specific details are provided to facilitate understanding, those skilled in the art will recognize that the disclosed embodiments may be practiced without all such details.

The “step-by-step process” for performing the claimed functions herein is a specific algorithm, and may be shown as a mathematical formula, in the text of the specification as prose, and/or in a flowchart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general-purpose computer, but rather the special purpose computer programmed to perform the disclosed algorithm.

A general-purpose computer, or microprocessor, may be programmed to carry out the algorithm/steps for creating a new machine. The general-purpose computer becomes a special purpose computer once it is programmed to perform particular functions pursuant to instructions from program software of the embodiments described herein. The instructions of the software program that carry out the algorithm/steps electrically change the general-purpose computer by creating electrical paths within the device. These electrical paths create a special purpose machine for carrying out the particular algorithm/steps.

The embodiments of the present disclosure may be implemented in a software program including instructions stored in a computer-readable storage medium. Some embodiments may be embodied as a computer-readable recording medium which includes computer-readable instructions. The computer-readable recording medium may include a computer storage medium, which may include volatile and non-volatile media, and detachable and nondetachable media which are technically implemented to store information including computer-readable instructions, data structures, program modules, and other data. The computer-readable storage medium may be provided in the form of a non-transitory storage medium.

Some embodiments of the disclosure may be provided in a computer program product, which may be traded between a seller and a buyer as a commodity. The computer program product may include a software program and a computer-readable storage medium having stored therein the software program. For example, the computer program product may include a product, such as a downloadable application, in a software program distributed electronically through a manufacturer of an electronic device or an electronic market. For electronic distribution, at least a part of the software program may be stored on the storage medium or may be generated temporarily. The storage medium may be a storage medium of a server of the manufacturer, a server of the electronic market, or a relay server for temporarily storing the software program. The computer program product may include a storage medium of a server or a storage medium of an electronic device, in a system including the server and the electronic device.

Although the invention has been explained in relation to its preferred embodiment, it is to be understood that many other possible modifications, variations, adaptations, combinations, and equivalent arrangements can be made without departing from the spirit and scope of the present disclosure. Features described in connection with one embodiment may be combined with, substituted for, or implemented independently of features of other embodiments unless expressly restricted or context clearly indicates otherwise. The disclosed systems, methods, and/or processes are not limited to any particular order, configuration, or sequence unless expressly stated or context clearly indicates otherwise. Steps described in the drawings or the description may be performed sequentially, in parallel, concurrently, or in different order.

The scope of protection is to be interpreted in accordance with the ordinary meaning of the claim language as understood by a person of ordinary skill in the art in light of the specification and prosecution history. Terms are given their ordinary and customary meaning unless expressly defined otherwise. Dictionary definitions that conflict with context usage do not control. Nothing in the specification is intended to read limitations into the claims that are not expressly recited.

Unless otherwise indicated, all numerical values, measurements, and/or specifications are approximately and include reasonable variations consistent with their intended function and customary practice in the art. Numerical ranges include all values and subranges within the stated range, including endpoints. The term “about” or “approximately” indicates reasonable measurement variability, including variations arising from standard measurement techniques.

Disjunctive phrases such as “A or B,” “A and/or B,” “at least one of A and B,” and so forth include any one of the listed elements or any combination thereof. Commas and slashes (/) likewise denote “and/or.” Ordinal terms such as “first,” “second,” “third”, etc., are used for distinction only and do not imply priority or sequence, unless expressly stated or context clearly indicates otherwise. Relational terms such as “connected” or “coupled” include direct and indirect relationships unless stated as “directly.” Terms such as “between” or “on” encompass both direct and indirect arrangements unless expressly limited. References to an element being “between” or “on” another element do not exclude intervening elements unless expressly stated or context clearly indicates otherwise. Spatial and/or directional terms describe relative relationships as illustrated and encompass alternative orientations in use.

The terms “comprise,” “include,” and similar variations denote non-exclusive inclusion. The use of “a” or “an” does not preclude additional identical elements unless expressly limited. The term “unit” may indicate a hardware component such as a processor or a circuit, and/or may indicate a software component that is executed by a hardware configuration such as a processor. Terms such as “system,” “device,” or “module” are not limited to any particular number, configuration, and/or physical arrangement of components. Such elements may be implemented as a single unit or distributed across multiple components, devices, circuit boards, and/or substrates, and may include movable or static elements.

What is claimed is:

1. A computer-implemented method for presenting advertisement elements in association with a real-time video feed, the method comprising:
receiving, from a host streamer profile associated with a streamer interface, an advertisement selection;
receiving, through the streamer interface and from the host streamer profile, platform-selection input identifying a first subordinate platform and a second subordinate platform from a plurality of third-party media platforms;
designating, based on the advertisement selection, a first advertisement element and a second advertisement element from a plurality of advertisement elements, wherein the second advertisement element differs from the first advertisement element;
initializing a real-time video feed associated with the host streamer profile;
simultaneously broadcasting the same underlying real-time video feed to the first subordinate and the second subordinate platform;
outputting the first advertisement element as a first overlay associated with presentation of the real-time video feed through the first subordinate platform;
outputting the second advertisement element as a second overlay associated with presentation of the real-time video feed through the second subordinate platform;
maintaining the underlying real-time video feed unchanged between presentation through the first subordinate platform and presentation through the second subordinate platform notwithstanding outputting the first overlay and the second overlay; and
associating information concerning presentation of the first advertisement element with the first subordinate platform and information concerning presentation of the second advertisement element with the second subordinate platform.

2. The computer-implemented method of claim 1,
wherein the advertisement selection corresponds to an advertisement category; and
wherein designating the first advertisement element and the second advertisement element comprises:
identifying a plurality of matching advertisement elements corresponding to the advertisement category; and
designating respective matching advertisement elements for presentation through the first subordinate platform and the second subordinate platform.

3. The computer-implemented method of claim 1,
wherein the advertisement selection corresponds to an advertiser profile; and
wherein the first advertisement element and the second advertisement element are designated from advertisement elements associated with the advertiser profile.

4. The computer-implemented method of claim 1, further comprising:
analyzing information associated with at least one of the host streamer profile, a viewer profile, one of the subordinate platforms, a geographical location, a language, viewer activity, or advertisement-performance information; and
designating at least one of the first advertisement element or the second advertisement element based on both:
the advertisement selection received from the host streamer profile; and
the analyzed information.

5. The computer-implemented method of claim 1, further comprising:
determining a first geographical location associated with a first viewer profile managed by the first subordinate platform;
determining a first language associated with the first geographical location;
determining a second geographical location associated with a second viewer profile managed by the second subordinate platform;
determining a second language associated with the second geographical location;
translating at least a portion of the first advertisement element into the first language;
translating at least a portion of the second advertisement element into the second language;
outputting the first translated advertisement element as the first overlay through the first subordinate platform; and
outputting the second translated advertisement element as the second overlay through the second subordinate platform;
wherein the same underlying real-time video feed remains unchanged by outputting the first translated advertisement element and the second translated advertisement element.

6. The computer-implemented method of claim 1, further comprising:
linking the host streamer profile with a first subordinate streamer profile managed by the first subordinate platform and a second subordinate streamer profile managed by the second subordinate platform;
communicating the real-time video feed to the first subordinate platform and the second subordinate platform through at least one of an application programming interface, a Real-Time Messaging Protocol, or a media server;
outputting the first advertisement element in association with the first subordinate streamer profile; and
outputting the second advertisement element in association with the second subordinate streamer profile.

7. The computer-implemented method of claim 1,
wherein the receiving the advertisement selection and the designating the first advertisement element and the second advertisement element are performed before the simultaneous broadcasting, during the simultaneous broadcasting, or both before and during the simultaneous broadcasting;
the method further comprising, during the simultaneous broadcasting:
receiving an updated advertisement selection;
based on the updated advertisement selection, designating a further advertisement element for presentation through at least one of the first subordinate platform or the second subordinate platform; and
outputting the further advertisement element as an overlay through the corresponding subordinate platform without stopping, pausing, breaking up, or interrupting the underlying real-time video feed;
wherein the underlying real-time video feed remains unchanged by outputting the further advertisement element.

8. The computer-implemented method of claim 1,
wherein at least one of the first advertisement element or the second advertisement element comprises at least one of an access link, a product link, a web hyperlink, or a scannable interactive component;
the method further comprising:
receiving an interaction with the corresponding advertisement element;
associating the interaction with the corresponding advertisement element and the subordinate platform through which the corresponding advertisement element was output;
following interaction with the at least one of the access link, the product link, the web hyperlink, or the scannable interactive component, tracking activity occurring after the interaction; and
determining whether a purchase associated with the corresponding advertisement element is completed.

9. The computer-implemented method of claim 8, further comprising:
associating at least one of advertisement-presentation information, impression information, hyperlink-interaction information, sale-conversion information, or compensation information with:
the corresponding advertisement element;
the subordinate platform through which the corresponding advertisement element was output; and
the real-time video feed with which the corresponding advertisement element was presented.

10. The computer-implemented method of claim 1, further comprising:
recording, in a blockchain record or a smart-contract record, an association among:
the subordinate platform through which at least one of the first advertisement element or the second advertisement element was output;
the at least one of the first advertisement element or the second advertisement element;
at least one of advertisement-presentation information, interaction information, or sale-conversion information; and
a compensation portion associated with participation by the subordinate platform;
wherein recording the association does not alter the underlying real-time video feed.

11. A system comprising:
a memory storing instructions; and
at least one processor configured to execute the instructions to perform operations for presenting advertisement elements in association with a real-time video feed, the operations comprising:
receiving, from a host streamer profile associated with a streamer interface, an advertisement selection;
receiving, through the streamer interface, input selecting a first subordinate platform and a second subordinate platform from a plurality of third-party media platforms;
designating, based on the advertisement selection, a first advertisement element and a second advertisement element from a plurality of advertisement elements, wherein the second advertisement element differs from the first advertisement element;
initializing a real-time video feed associated with the host streamer profile;
simultaneously broadcasting the same underlying real-time video feed to the first subordinate platform and the second subordinate platform;
outputting the first advertisement element as a first overlay associated with presentation of the real-time video feed through the first subordinate platform;
outputting the second advertisement element as a second overlay associated with presentation of the real-time video feed through the second subordinate platform;
wherein the underlying real-time video feed presented through the first subordinate platform is the same underlying real-time video feed presented through the second subordinate platform and remains unchanged by outputting the first overlay and the second overlay; and
associating information concerning presentation of the first advertisement element with the first subordinate platform and information concerning presentation of the second advertisement element with the second subordinate platform.

12. The system of claim 11,
wherein the operations further comprise receiving, by a host platform, the advertisement selection from the host streamer profile managed by the host platform;
wherein the first subordinate platform manages a first subordinate streamer profile and the second subordinate platform manages a second subordinate streamer profile;
wherein the host streamer profile is linked with the first subordinate streamer profile and the second subordinate streamer profile;
wherein the host platform communicates with the first subordinate platform and the second subordinate platform through at least one of an application programming interface, a Real-Time Messaging Protocol, or a media server; and
wherein the first advertisement element is output in association with the first subordinate streamer profile and the second advertisement element is output in association with the second subordinate streamer profile.

13. The system of claim 11,
wherein the advertisement selection corresponds to at least one of an advertisement element, an advertisement category, an advertisement subject, an advertiser profile, a product, a service, an advertisement type, or a brand.

14. The system of claim 13,
wherein at least one of the first advertisement element or the second advertisement element comprises:
a digital representation associated with the host streamer profile; and
a visual component associated with at least one of an advertiser, a company, a product, a service, or a brand message;
wherein the digital representation comprises at least one of a two-dimensional image, a three-dimensional image, a still image, a motion graphic, an animated image, non-fungible-token content, an avatar, or an anonymous avatar.

15. The system of claim 11,
wherein the operations further comprise:
determining a first geographical location associated with a first viewer profile managed by the first subordinate platform;
determining a first language associated with the first geographical location;
determining a second geographical location associated with a second viewer profile managed by the second subordinate platform;
determining a second language associated with the second geographical location;
providing the first advertisement element in the first language; and
providing the second advertisement element in the second language;
wherein the first advertisement element and the second advertisement element differ according to at least one of geographical location, language, viewer-profile information, viewer activity, advertisement category, advertisement type, product, service, or brand content.

16. The system of claim 15,
wherein providing the first advertisement element in the first language comprises translating at least a portion of the first advertisement element into the first language; and
wherein providing the second advertisement element in the second language comprises translating at least a portion of the second advertisement element into the second language.

17. The system of claim 11,
wherein the operations further comprise:
generating at least one of environmental data associated with an environment or user data associated with a user state;
analyzing the environmental data or the user data; and
based on the analyzing, customizing at least one of the first advertisement element or the second advertisement element;
wherein the customizing comprises adjusting at least one of brightness, size, coloration, content, or animation of the corresponding advertisement element.

18. The system of claim 11,
wherein the operations further comprise determining at least one presentation characteristic or presentation duration for at least one of the first advertisement element or the second advertisement element;
wherein the presentation characteristic comprises at least one of position, orientation, location, movement, brightness, size, or coloration; and
wherein outputting the corresponding advertisement element comprises outputting the advertisement element according to the determined presentation characteristic or presentation duration.

19. The system of claim 11,
wherein the information concerning presentation of a selected advertisement element, comprising at least one of the first advertisement element or the second advertisement element, comprises at least one of advertisement-presentation information, impression information, hyperlink-interaction information, click-through activity, conversion activity, sale-conversion information, or subordinate-platform participation; and
wherein the operations further comprise associating the information with the selected advertisement element and with the subordinate platform through which the selected advertisement element was output.

20. The system of claim 11,
wherein the operations further comprise distributing a compensation amount associated with presentation of at least one of the first advertisement element or the second advertisement element according to an incentive structure;
wherein the compensation amount comprises:
a user portion assigned to an account associated with the host streamer profile;
a host portion assigned to a host platform; and
at least one third-party platform portion assigned to at least one of the first subordinate platform or the second subordinate platform; and
wherein the compensation amount corresponds to at least one of advertisement duration, advertisement type, advertisement content, advertisement time, advertisement cost, or subordinate-platform participation.
